(19) United States
(12) Patent Application Publication
(10) Pub. No.: US 2023/0183966 A1
(43) Pub. Date: Jun. 15, 2023

(54) COMPOSITE PANELIZED BUILDING SYSTEM AND METHOD

(71) Applicant: DECOi Inc., Charlestown, MA (US)

(72) Inventor: Mark Goulthorpe, Charlestown, MA (US)

(21) Appl. No.: 18/080,689

(22) Filed: Dec. 13, 2022

Related U.S. Application Data
(60) Provisional application No. 63/289,029, filed on Dec. 13, 2021.
(60) Provisional application No. 63/289,036, filed on Dec. 13, 2021.
(60) Provisional application No. 63/289,052, filed on Dec. 13, 2021.

(51) Int. Cl. E04B 1/61; E04B 1/14; B32B 3/06; B32B 7/02; B32B 5/02; B32B 5/18; B32B 9/02; B32B 21/10; B32B 5/24; B32B 9/04

(52) U.S. Cl. CPC E04B 1/6145; E04B 1/14; B32B 3/06; B32B 7/02; B32B 5/02; B32B 5/18; B32B 9/02; B32B 21/10; B32B 5/245; B32B 9/047; B32B 7/12

(57) ABSTRACT

Systems and methods are described herein for a panelized building assembly. In one example, an assembly may include one or more of a first composite planar panel, and second composite planar panel, and a planar joining element. The first and second planar panels may include a core material sandwiched between two fiber-reinforced skin elements. Each of the panels may include a first block of fiber-reinforced material coupled to at least one of the skin elements, which may define two slots for receiving the planar joining element. In some cases, the planar joining element, when placed within the slots of two panels to be joined, may transfer a load between the fiber-reinforced material of the two panels. The resulting joint may form a water-tight and fire-retardant seal.

### CROSS REFERENCE TO THE RELATED APPLICATIONS

This application claims priority to U.S. Provisional Patent Application No. 63/289,029, filed Dec. 13, 2021, entitled “COMPOSITE PANELIZED BUILDING SYSTEM AND METHOD,” U.S. Provisional Patent Application No. 63/289,036, filed Dec. 13, 2021, entitled “INTEGRATED COMPONENTS AND SERVICES IN COMPOSITE PANELIZED BUILDING SYSTEM AND METHOD,” and U.S. Provisional Patent Application No. 63/289,052, filed Dec. 13, 2021, entitled “SUB-DERMAL JOINTING FOR COMPOSITE PANELIZED BUILDING SYSTEM AND METHOD,” which are hereby incorporated herein by reference in their entirety and for all purposes.

### BACKGROUND

The predominant logic of current building construction involves the assemblage of multi-material, industrially-produced components, mainly comprised of minerals and metals (steel, concrete, aluminum, gypsum, copper, etc.). Implicitly such buildings are high mass and high energy-intensity, given the mining, purifying, smelting, baking, and other processes, etc. that they rely upon. This imposes a significant embodied energy footprint to such buildings, which at civilizational scale has portent of vast CO2 pollution given the anticipated doubling of buildings globally by 2050.

This late-industrial logic of assemblage of industrial readymade components means that buildings are comprised of thousands or tens of thousands of discrete parts, and implicit in this is a vast number of joints and mechanical connections. Inherently this means there will be differential thermal expansion between elements, with joints prone to leaking energy: a high in-use energy footprint. Current embodied and in-use energy consumption of buildings is some 40% of global energy production, before the anticipated doubling of global building stock. Basic physics dictates that buildings be low mass and low energy intensity to reduce their embodied footprint; and equally that buildings be few-joint, well-insulated, thin-skin assemblies, with a vast reduction in parts, materials, connections and cold bridges across insulation.

There is also an affordability crisis in the building sector, where the multi-trade, multi-material methods of the dominant building paradigm are imposing very high labor and logistical complexity that results in high cost. The sheer number of components and the dizzying choice they offer, has meant that the building sector has not increased its efficiency over the past 30 years, despite computation. This contrasts with the manufacturing sector that has embraced new materials that lend themselves to CAD-CAM automation, witnessing a doubling of productivity in the same period.

In view of the foregoing, a need exists for an improved material-processing system and method for rapid manufacture and assembly of minimal environmental footprint buildings in an effort to overcome the aforementioned obstacles and deficiencies of conventional multi-material, multi-trade building systems.

### BRIEF DESCRIPTION OF THE DRAWINGS

Various techniques will be described with reference to the drawings, in which:

FIGS. 1-4 illustrate different views of an example 9-panel building corner disassembled into polyfunctional composite structural panels and sub-dermal structural joining elements, in accordance with at least one embodiment;

FIG. 5 illustrates an example diagram of a sub dermal joint, which may be used to connect two or more of the building panels, in accordance with at least one embodiment;

FIG. 6 illustrates an example diagram of a multiple views of a sub-dermal joining element used to bond two building composite panels, in accordance with at least one embodiment;

FIGS. 7 and 8 illustrate example diagrams of exploded views of a sub-dermal joint and edges that form the joint, in accordance with at least one embodiment;

FIG. 9 illustrates an example diagram of a 90-degree sub-dermal structural joint in accordance with at least one embodiment;

FIG. 10 illustrates a diagram showing one example of an orthogonal arrangement of sub-dermal structural joining elements showing 90-degree corners and a 90-degree T-junction, in accordance with at least one embodiment;

FIG. 11 illustrates a diagram of an example of sub-dermal edge material with cavity for a sub-dermal joining element, in accordance with at least one embodiment;

FIGS. 12-25 illustrate example stages in an example process to manufacture a building panel, in accordance with at least one embodiment;

FIG. 26 illustrates an example process for manufacture a building panel, in accordance with at least one embodiment;

FIGS. 27-28B illustrate example manufacturing facility layouts that may be utilized to manufacture the descried building panels, in accordance with at least one embodiment; and

FIGS. 29-47 illustrate various example building constructions that may be constructed using the described building panel and joining techniques, in accordance with at least one embodiment.

### DETAILED DESCRIPTION

Systems and methods are descried herein relating to the manufacture and assembly of buildings from planar fiber-reinforced composite structural panels joined together by joining elements (or in some cases non-joined together to form a kit or assembly) to create fully functional building envelopes and building elements. In some aspects, the panels can serve as external or internal walls, floors, roofs, or be used for fixed furniture such as counters, cupboards, shelves, beds, and even dynamic planar elements such as doors, screens, shutters. The individual panels can be of any suitable shape, size and thickness, including rectangular in various embodiments. In other cases, the individual panels may include any suitable planar polygonal form, with as many sides and as many angles as might be needed or desired to create a given spatial arrangement. The panels in various examples can be joined to neighboring panels to attain and provide permanent, semi-permanent or temporary structural, waterproof, acoustical and fire performance adequate to the specific need in that location. In some embodiments, the panels can also have open edges such as at the end of a wall, or at an opening in a wall, or at the edge of a roof, where these edges can also attain waterproof, acoustical and fire performance adequate to the specific need in that location or for other suitable purpose.

The panels in various examples can be adjacent to but be separated from other panels such as where a panel is a door or screen where it may be desirable to include a gap between the panels to permit the dynamic element (e.g., door, screen, window, etc.) to move or to close into a seal or gasket that may attain waterproof, acoustical, thermal and fire performance adequate to the specific needs in that location, or for various other suitable purposes. Non-joined panels of some examples can be proximate with adjacent panels (e.g., touching one another), or be co-joined with a seal or gasket, or be separated by a gap, as needed to attain waterproof, acoustical, thermal and fire performance adequate to the specific needs in that location or for other suitable purpose. Because the individual panels can be of any suitable shape and size, the building exterior and its interior spatial arrangement can be of any suitable shape or size in various embodiments, including any suitable number of such joined and non-joined variable planar panels.

One class of material-processing that has proved technically sophisticated and economically advantageous in various embodiments is composites, which can be developed hand-in-glove with digital design, analysis and fabrication methods. Composite building technology of various examples discussed herein can aim to revise building procurement by automated production of composite materials. Lightweight, thin-skin, large-component polymeric composites offer a desirable building logic in various embodiments, offering low energy intensity, low mass, few-joint, low thermal expansion building envelopes. Composites as a class of materials offer a vast reduction in parts since they are polyfunctional, so able to perform, say, structural, waterproofing and insulation functions in one composite element, thus reducing or eliminating the many-material, many-trade logic of current buildings. An important benefit provided by the described techniques is the potential reduction in time in fabricating and assembling buildings by vivid reduction of components, which is a significant aspect in the cost of buildings.

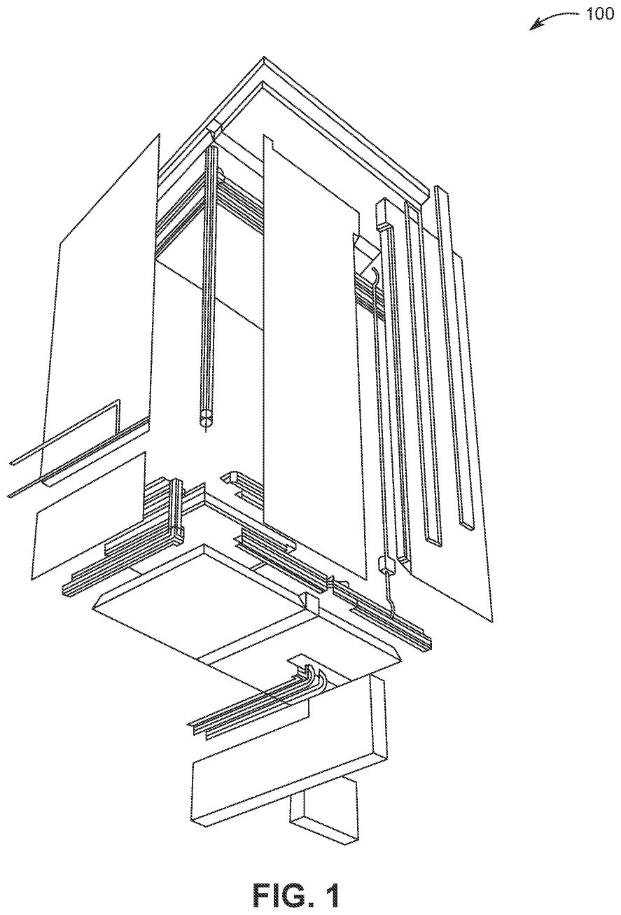

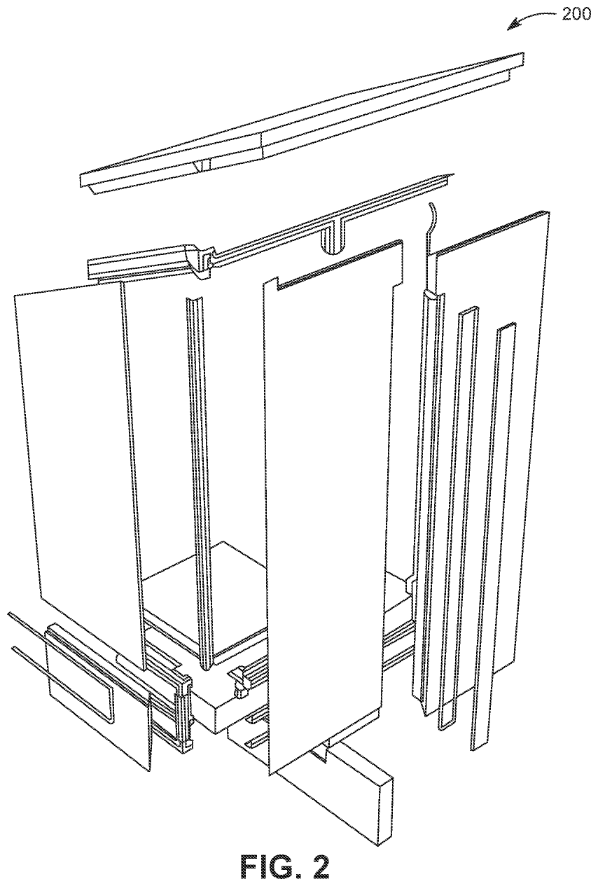

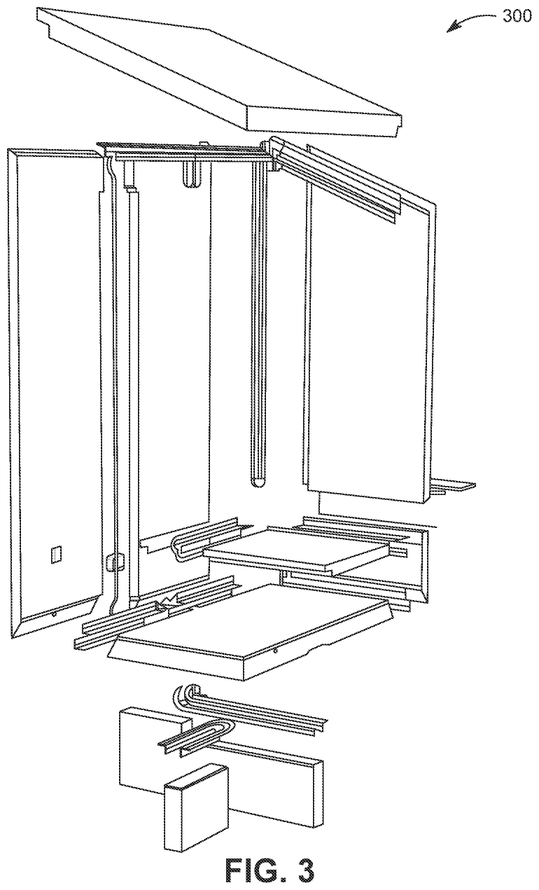

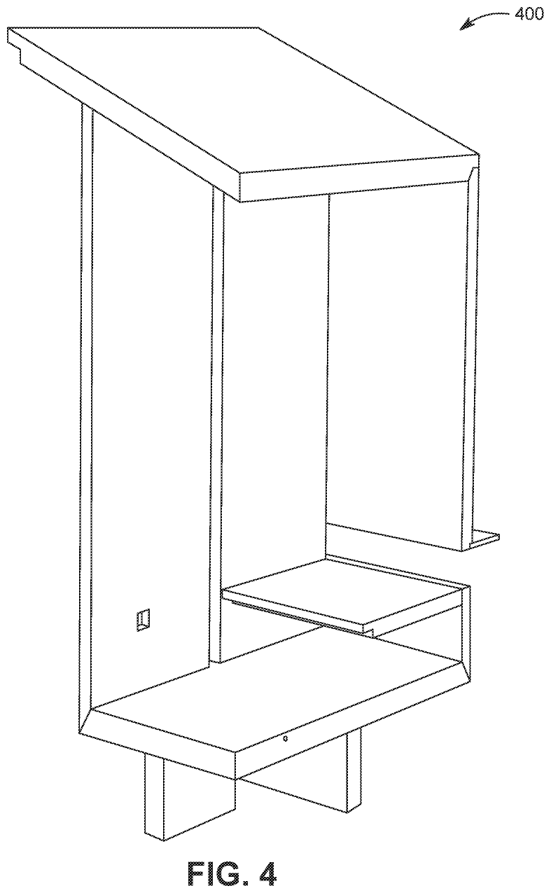

FIGS. 1-4 illustrate different views 100, 200, 300, 400 of an example 9-panel building corner disassembled into polyfunctional composite structural panels and sub-dermal structural joining elements, such as will be described in greater detail below. Using the described techniques to design and construct building panels and joining elements, various designs and structures may be realized. The design of joining elements and building panels, as described herein, can with only slight modification, be used to construct almost unlimited configurations of structures, as will be described in greater detail below.

In some examples, the described techniques may include a panelized building assembly comprising a double skeleton of planar connectors, positioned parallel to and behind the inner and outer building surfaces. The planar elements may be folded symmetrically about the bisected angle between adjacent surfaces so as to form a coherent and continuous double layer that can, in some cases, offers structural, fire, acoustical and waterproofing performance consistently between every panel. The connectors may extend into the mass of a block of material that forms a continuous edge around the perimeter of every panel, which is bonded continuously to the fiber-reinforced skin of the panel that it is the edge of, and to the core material that the inner and outer fiber reinforced skins are also continuously bonded to.

In some cases, the edges may offer structural, fire, waterproofing and acoustical performance around all panel edges, inside and outside, and may be comprised of a single liquid that has solidified, or a series of linear solid elements, with or without fiber or other structural reinforcement. The connectors may be adhesively bonded or mechanically connected with sealants or gaskets to form a coherent and consistent barrier to water, sound, fire between inner and outer building surfaces.

Between the centerline of the inner and outer structural connectors, in some cases, there may be a structural material that connects the core of adjacent panels across the joint plane to permit shear load transfer between the cores that complements the load carrying capacity of the inner and outer connectors. This material may be an elastomeric adhesive, or in some cases a panel or section of a similar material as used for the skin elements. In some high-load cases, there may be additional material connecting the inner and outer connectors so as to permit them to act as a unitary structural element rather than as flanges of a beam co-jointed by the filler between the cores.

### Example Panel Build-up

The panels of various embodiments can include at least two fiber-reinforced exterior skins, one on each side of a core material to which they can be fully bonded. The fibers can be consolidated in place by a solid matrix material that can allow for transfer of structural load carried in the fibers, which can form a composite material such as glass fiber and polymeric resin, or carbon fiber and polymeric resin, or any other suitable fiber/matrix materials, or the like. The skins may be adhesively bonded to the core material by a tertiary material such as a glue or be bonded by the matrix material itself to the core material, and in various examples attaining a coherent connection over a portion of or over the entire surface of skin and core.

The fiber-reinforced skins can be applied to the core material to form a panel by a variety of methods: for example, the fiber and matrix can be pre-consolidated and adhesively bonded using a glue, or a liquid matrix can be solidified via infusion, wet-pregging, pre-pregging, hand lay-up or any other suitable method to attain a (e.g., fully) consolidated and bonded fiber/matrix skin.

The core material may include one or several different materials bonded together to form a coherent solid panel. In some embodiments, each material can have different properties, such as for example thermal or acoustical absorption attained by one layer bonded to a thermally insulating layer: together they offer poly-functionality to meet a range of building performance criteria specified in building codes or to meet other performance criteria. The sandwich build-up of the core material can be configured in some examples to attain a given performance adequate to the specific needs in that location or other suitable purpose. In some cases, different core materials may be used for different locations or structures of a building, such as may have different safety requirements, (e.g., a first set of materials, having higher fire retardant qualities, may be selected for use near or proximate to heat sources, whereas another set of materials may be used for structures or walls facing the outside weather, such as may be waterproof or have insulating qualities not affected by exposure to water).

In some cases, a functional need of contemporary buildings may be their thermal performance. As a result, there can be an advantage in some embodiments to minimizing the mass of the cores for optimal thermal performance, so the core materials in some examples can comprise low density, high thermal insulating materials that are deployed to a given thickness to attain thermal performance adequate to the specific needs in that location or for other suitable purpose. For example, a 4″-8″ thick wall in the external envelope of buildings in USA may be used or required to attain energy code compliance (further examples can include 3″-9″, 4.5″-7.5″, 5″-7″, 5.5″-6.5″, and the like). Examples can include using expanded polystyrene or PET foam, but any suitable core material may be used including materials such as balsa, and the like.

Because the stiffness of skin-core-skin panels in various embodiments increases to the power of 4 with increasing distance between skins, having thick, low-density cores can offer thermal and/or structural advantage for buildings. In some examples, building codes can demand low-deflection floors and roofs despite high live and snow load criteria. However, added core thickness can mean added core mass in some examples that may require more strength and stiffness of the fiber-reinforced skins to resist its load, so core thickness on various embodiments balances between minimal thermal and structural performance to meet code criteria adequate for that specific location or for other suitable purpose.

The fiber-reinforced composite panels in a given multi-panel building assembly may have consistent properties or varying properties. In one example adjacent panels can have similar or identical properties, but panels performing different functions can have different properties such as, for example, a floor and a wall having different structural capacity, or an internal and external wall having different thermal properties. Different properties can be attained in some embodiments by different build-up and dimensions of the composite panel, devised to attain adequate performance in a given location or for other suitable purpose. In one example, adjacent panels that connect to form a single building element such as a wall or a floor panel, can be of the same thickness, but the sub-dermal core and skin thickness may vary from panel to panel according to the specific performance requirements in that location despite the overall panel thickness being constant or for other suitable purpose.

The skin-core-skin assembly in various embodiments can attain a structural coherence (e.g., much as a beam does by arrangement of two flanges and a connecting web), which can allow the (e.g., fiber reinforced) skins to carry tension and/or compression and the core to carry shear such that the panel performs as a planar beam, distributing load especially into the stiff/strong fibers. This can allow each panel to function structurally, whether in isolation (e.g., as in a non-joined door or screen), or as part of a joined multi-panel assembly (e.g., as in a building wall or roof). Where the panels are joined, in various embodiments, they can have opportunity to perform collectively as a structural assembly, but where load transfer between adjacent panels can be desirable to permit structural coherence of multi-panel assemblies. In other words, in some examples it can be desirable for the joints to transfer load from fiber-reinforced skin to fiber-reinforced skin is a manner that allows the multi-panel arrangement to perform holistically to attain a structural performance as needed in a given location per building code (or other) criteria or for other suitable purpose.

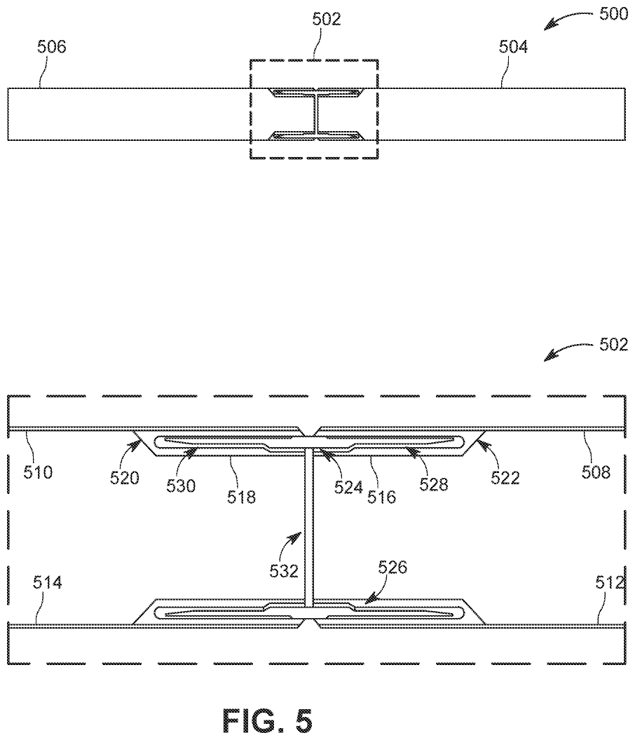

FIG. 5 illustrates an example diagram 500 of a sub-dermal joint 502, which may be used to connect two or more of the above-described panels 504, 506. For the sake of clarity, only one of joining elements 524, 526 will be described in relation to reference numerals below. It should be appreciated that joining element 526 and corresponding cavity may incorporate aspects of the joining element 524 and cavity described below, such as in a mirrored fashion.

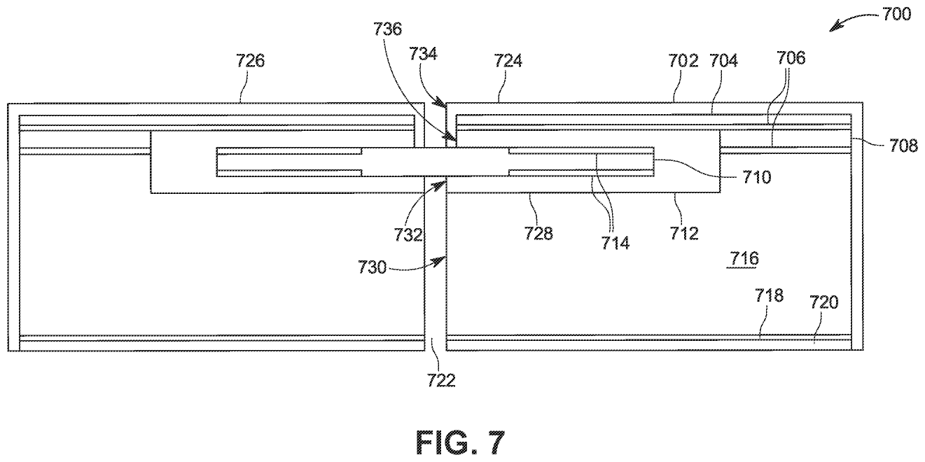

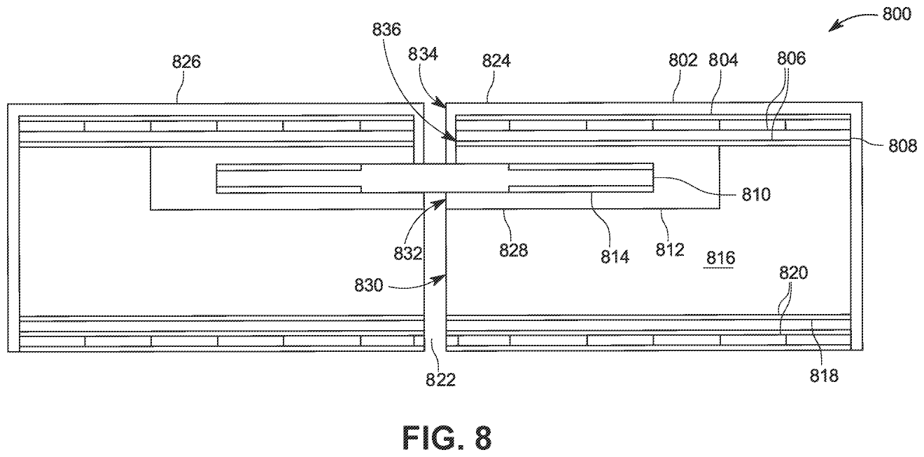

Diagram 500 illustrates an example of a 180-degree panel-to-panel (or beam to beam) sub-dermal joint 502 showing (e.g., fiber-reinforced) structural skins 508, 510, 512, 514, solid sub-dermal edges 516, 518 with cavities 520, 522, structural sub-dermal joining elements 524, 526, adhesive 528, 530 in the cavities around the structural joining element 524, 526, and adhesive 532 between core edges between sub-dermal jointing elements 524, 526. In some cases, sub-dermal joint 502 may include one or more aspects of sub-dermal joints 700 and 800 described in more detail below in reference to FIGS. 7 and 8. In some cases, sub-dermal joint 502 may be a mirrored example of sub-dermal joints 700 and 800, such that two biscuits may be utilized, in a layered arrangement as described in sub-dermal joints 700 and 800 to form joint 502.

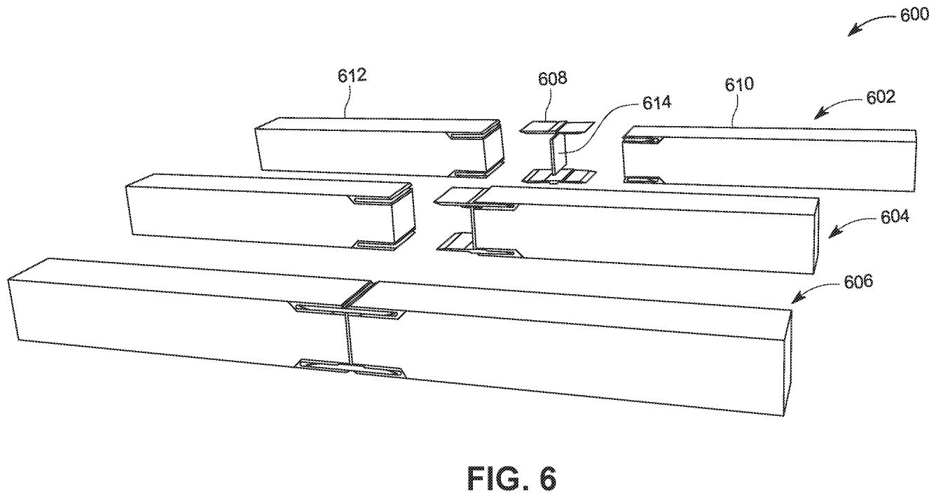

FIG. 6 illustrates an example diagram 600 of multiple views 602, 604, 606 of sub-dermal joining element 608 (e.g., adhesively) being bonded into a cavity in a sub-dermal mass bonded to the core and skin of each composite panel 610, 612. Sub-dermal joining element 608 may be an example of joining elements 524, 526 of sub-dermal joint 502 described above in reference to FIG. 5. In some examples, additional skin or reinforced material (e.g., the same or different than the skin material of the panels 610, 612) may be placed in between mating edges of the two panels 610, 612, as cross member and bonded to each other and the mating edges, to further aid in joining the two panels and protecting the core material of the two panels. In other cases, a layer of adhesive, or material that bonds to the cores when formed, can be used as element 614, in place of a distinct skin material with separate adhesive. In some cases, element 614 mat be an adhesive layer allowing the two cores to transfer shear load between the cores of adjacent panels. In yet some cases, element 614 may function to seal off cores of the two panels from external environmental influences, increase fire safety, ad insulating properties, and the like.

In this example, such planar multi-panel assembly of joined panels can attain a coherent structural performance by a ubiquitous topologically-consistent sub-dermal jointing between panels. This jointing can allow such fiber-reinforced multi-panel assemblies to function as building structure per building code (or other) criteria or for other suitable purpose.

Given that the sub-dermal jointing of the planar fiber-reinforced structural panels of various embodiments can allow the overall assembly to function structurally, some embodiments may be thought of as a quasi-monocoque structure—quasi because it can be in fact comprised of multiple planar elements co-joined to form a coherent structural whole. Accordingly, various examples can attain quasi-monocoque structural performance for (e.g., entirely) variable arrangements of planar composite panels, such that no other structural system need be provided such as beams and columns, or that less of an additional structural system need be provided. In some cases, however, beams and columns can be added to such an arrangement to offer additional structural performance, but the quasi-monocoque performance offered by the sub-dermal jointing of (e.g., fiber-reinforced) panels can attain structural load-transfer sufficient for most building applications.

In addition to structural performance, in various embodiments, it can be desirable for the joints between panels to attain a necessary or desired thermal, acoustical and/or fire performance needed in a given location, so that the multi-panel assembly meets building code (or other) criteria, or for other suitable purpose. The core materials in various examples of composite structural panels can be low density to minimize mass for structural efficiency, such that they may be vulnerable to insects, water, mold, fire. As a result, it can be desirable for the core material to be protected in the event that it might be exposed, such as an edge or at a penetration point. An example of the described systems and techniques can attain protection of most if not every edge and every penetration of the fiber/matrix skin to meet building performance needs by defending vulnerable cores from such hazards (whereas some examples can attain protection for at least some edges and at least some penetrations). In some examples, protection of sub-dermal core materials can be via a (e.g., continuous) barrier of dense, resilient, waterproof, and/or fire-retardant material that is (e.g., fully) bonded to the fiber/matrix structural skins.

### Example Sub-dermal Edges

FIGS. 7-8 illustrate examples diagrams 700 and 800 of an exploded view of a sub-dermal joint and edges that form the joint, but showing only one side of the panel, such that a full joint would be mirrored on the bottom of each diagram 700, 800 to include two planar biscuit elements. FIG. 7 illustrates an example 700 of a joint between two mEP laminated panels. While FIG. 8 illustrates an example 800 of a joint between two RodPack infused panels. These materials are only given by way of example. It should be appreciated that other types of materials may be used for the outer skin portions of building panels as described herein and/or for various components of a sub-dermal joining element, as will be described in greater detail below. In some cases, different adhesive or intermediate layers may be utilized on the outside of, in between, or below the skin elements to provide various functionality, including adhesion to another layer, or for various other reasons. As described below, only the layers of one panel 724, 824 will be described below; it should be appreciated that the layers of the other panel illustrated, panels 726, 826, may include similar layers, features, properties, etc.

In various embodiments, such as the examples illustrated in FIGS. 7 and 8, the dense, sub-dermal material, represented by blocks 728, 828, that can protect the core at edges, can form part of a multi-material core, bonded to the other core materials to form a coherent material mass. Blocks or portions of this dense, reinforced sub-dermal material, such as represented by blocks 728, 828 can be bonded to the core 716, 816 and/or at least one of reinforced skin elements 704, 720 and 804, 820 as a solid element by use of an adhesive material 706, 718, 806, 818 that links core 716, 816 and skin elements 704, 720 and 804, 820 to blocks 728, 828, or the sub-dermal material blocks 728, 828 of the edge can themselves act as an adhesive when applied as a liquid or semi-liquid that bonds to the core 716, 816 as it solidifies. Blocks 728, 828 may form slots 712, 812 that are shaped and sized to receive a planar joining element or biscuit 710, 810, that in some cases with adhesive or mechanical fastening means, can tightly bond two panels 724, 726, and 824, 826 together. As used herein, panels 724, 726, 824, 826 may have edges 730, 830 (e.g., a side of a panel 724, 726, 824, 826 that is at an angle to skin elements 704, 720 and 804, 820 and core 716, 816, such as may be bonded to another edge of another panel). In some cases, blocks of reinforced material 728, 828 may form at least part of these panel edges 730, 830. In some cases, as used herein, a panel edge may refer to the entire edge of a panel, such as including outward facing edge 730, in the example of diagram 700, and the outward edges formed by the slot in the sub-dermal blocks, such as formed by slot 712. In some cases, this panel edge may be formed by the different layers illustrated in diagrams 700 and 800, such as including core material 716. In other cases, edges 730, 830 may be faced with some type of reinforced material, (e.g., skin material, material used to form blocks 728, 828, or something similar).

In some cases, as used herein, a sub-dermal edge may refer to the slot 712, 812, formed by blocks 728, 828, and outward facing edges 732, 832 of blocks 728, 828, or simply to blocks of material 728, 828. In various examples, blocks 728, 828 may take various sizes and shapes, such as including rectangular blocks, with or without rounded corners, or various other shapes. In some cases, sub-dermal edge may include a portion of skin elements 734, 834 that wrap down onto panel edge 730, 830 such as represented by rectangular elements 734, 834. In other cases, where skin elements 734, 834 are not present, an upper portion 736, 836 of blocks 728, 828 may form part of the sub-dermal edge of the panels (and may extend to the outward facing surface of edge 730, 830). Similarly, slots 712, 714 may take on various sizes and shapes to accommodate different sizes and shapes of biscuits 710, 810.

The sub-dermal solid edges in various examples can be placed locally as needed or desired for structural and other performance needs or for other suitable purpose. So the dense edge material forms a frame or skeleton of sub-dermal edges (e.g., including faces 732, 832 and faces of slot 712, 812, and in some cases faces 736, 836) in one example shallow in depth, under both inner and outer skins, but where it can be deployed in another example across the full depth of the core 716, 816/edge 730, 830 at the end of a wall, or to form a full-depth edge at an opening of a window or door. The sub-dermal edge material, being quite dense and structurally performative relative to the main core of the panels in some embodiments, can tend to conduct heat better than the insulating core 716, 816. As a result, in various examples, it may only be full-depth as strictly needed for functional purposes (or other desirable reason), and when full-depth it can, in one example, be kept to minimal thickness to avoid establishing a cold bridge between inside and outside of the building or for other suitable purpose.

While in some embodiments, the dense and structurally-resilient sub-dermal edge material may not perform thermal insulation as well as the (e.g., low-density) core material, nonetheless in various examples, it may offer thermal mass that can ensure those regions remain cooler during a fire event than the areas that do not have such sub-dermal mass. In other words, in various embodiments, the sub-dermal edges can keep the skin/edge bond relatively cool, which may ensure that the composite structural skin 704, 720 and 804, 820 remains bonded to the edge and blocks 728, 828, and the edge/blocks 718, 828 to the core 716, 816, longer than in other areas of the panel. A function of the sub-dermal edge in various examples can be to offer a thermal shadow against radiant heat from a fire event in order to keep the structural skin 704, 720 and 804, 820 (e.g., fully) bonded at some or all edges to avoid it or the edges peeling away from and exposing the core 716, 816, serving to keep fire out of the low-density core, which in various embodiments can have detrimental consequences if it ignites or melts. Said otherwise, in some embodiments, addition of a thermal mass at some or all edges of composite structural skins can serve to keep the matrix and/or adhesives cooler than in other areas of the panel, which may allow the skin/edge/core assembly to hold together longer than it would otherwise do.

In one example, the sub-dermal edge/blocks 728, 828 is comprised of a material with fire-retardant properties that are equal or better than the matrix or adhesives used in the composite structural panel, which in various embodiments can ensure that some or all of the panel edges maintain their integrity longer than the other elements in a fire event, which may disallow structural failure nor ingress of fire into the core cavity at the vulnerable edges. Some such embodiments can be useful in mitigating the peeling-off of the (e.g., fiber-reinforced) structural skins in a fire event.

In various embodiments, one or more sub-dermal edges/blocks of material 728, 828 can be bonded to both the fiber-reinforced skins 704, 720 and 804, 820 and any contiguous core materials 716, 826, for example via a compatible adhesive that co joins the different chemistries, or by direct bonding of the sub-dermal edge material and skin matrix material solidifying adjacent to the other materials or other suitable method. The dense and resilient sub-dermal material in some embodiments can establish a solid mass that permits effective severing, milling and/or routing, which in some examples may establish an accurate and/or precise edge to the fiber-reinforced structural composite panels 724, 726, 824, 826. Fiber-reinforced polymers of some examples can be difficult to cut cleanly and/or precisely as they tend to fray, such as if the core material offers no real solidity nor support to a cutting tool. In various embodiments, the sub-dermal edge can be over-sized to allow for tolerance and/or to offer a strong and/or stable substrate, which may permit a clean and/or accurate trimming of the panel in various examples.

The sub-dermal edge/blocks 728, 828 of various embodiments can serve as a load-transfer medium for the joining element between structural panels. Some examples can include a continuous and consistent cavity or slot 712, 812 within the sub-dermal edge, established in various embodiments wherever a connection between adjacent panels may be desirable. The cavity 712, 812 in various embodiments can be land-locked within the sub-dermal mass of panels 724, 726, 824, 826, including in some embodiments at the mid-point of its depth, and of consistent depth from the plane that may define the mid-point of the joint between adjacent panels. This cavity 712, 812 in various embodiments can establish a recess into which a load-carrying planar element or biscuit 710, 810 can be inserted, with various examples providing an allowance for tolerance around some or all surfaces of the structural joining element 710, 810, which in some embodiments can provide for assembly of adjoining panels and/or structural joining elements not being hampered by the joints being too tight. The structural joining element 710, 810 can then be secured by mechanical fastening and/or by chemical adhesion to the sub-dermal edge, which in various examples can allow load transfer from fiber-reinforced skins 704, 804 to sub-dermal edge 728, 828 to joining element 710, 810 and then back “out” to sub-dermal edge and (e.g., fiber-reinforced) skin of the adjacent panel.

In various embodiments, some or all panels 724, 726, 824, 826 can comprise two fiber-reinforced structural skins 704, 720 and 804, 820, one on either side of a core material 716, 816, and some or all skins can have a continuous sub-dermal edge/blocks 728, 828, with a cavity 712, 812 that allows a structural joining element 710, 810 to link skin-to-skin to establish a quasi-monocoque structural performance. In other words, in various embodiments, each skin links via sub-dermal edges and structural joining elements to the corresponding skin in the next panel, with load transfer from skin to skin only minimally diverted to the sub-dermal structural joining element.

The structural joining element 712, 812 has a structural capacity in one example a little higher than the fiber-reinforced skins 704, 720 and 804, 820 so that it is stronger and less likely to fail than the panel itself The structural joining element is in one example a shaped linear strip, either planar or folded at its center, that extends parallel to the fiber-reinforced skin 704, 720 and 804, 820 of the composite panel to a standard distance from a plane that lies on the mid-point of the joint between the two panels. In other words, in such an example, the structural joining element 712, 812 can comprise a structurally reinforced strip that is folded to the same angle as the composite panels, its central axis (folded or planar) placed on the centerline between the adjacent panels, extending equally into the cavities in the sub-dermal edge material. In one example, all structural joining elements may lie at the same depth below the fiber-reinforced skins, establishing a uniform topology of joint that occurs at the same depth everywhere below any fiber-reinforced skin. It may be a ubiquitous logic, typically the same at floors, walls, ceilings, etc. despite their varying thicknesses and sizes.

In various embodiments, where the joining element 712, 812 is mechanically fastened, it can be desirable for the gap between the sub-dermal edge/slot 712, 812 and the joining element 712, 812 to be sealed with a gasket or a mastic sealant so as to attain water-and air-tightness along the totality of the joint. For this reason, adhesive bonding of the structural joining element into the sub-dermal edge cavity is one preferred option of some embodiments such that there is structural continuity that also establishes water- and air-tightness, as is needed or desired in building envelopes or for other suitable purpose. A continuous adhesive bond can also suit various examples of thin-skin fiber-reinforced structures where mechanical fastenings would need reinforcement locally in a manner akin to the reinforcing rings used at punched holes on sheets of paper for binding: adhesives can be better suited to the distributed load-transfer achieved in the fiber-reinforced structural skins in composite panels in some embodiments.

The sub-dermal edges/slots or cavities 712, 812 in various examples are preferably tapered (or rounded) at the inner edge closest to the core 716, 816 so that load carried from the structural joining element 710, 810 into the sub-dermal edge 728, 828 material flows naturally into the fiber-reinforced skin 704, 804 or for other suitable purposes. In some embodiments, this can prevent load build-up as would occur with a rectangular sub-dermal block 728, 828, which may add stress to some examples of a fragile low-density core material 716, 816. However, a rectangular block is one possible and usable instance of the joint technology.

The structural joining element 710, 810 can, in one example, be fatter in the middle, tapering to the edges as load is shed into the adjoining sub-dermal edge material 728, 828. It may fatten in its mid-section to fit quite snugly in the cavities in the sub-dermal edge material to contain any adhesive that might otherwise leak out of the joint as the structural joining element 710, 810 is inserted into slots 712, 812. There can be a space between the sub-dermal cavity 710, 810 and the structural joining element 712, 812 to permit adhesive to fill the gap to bond the joining element and the sub-dermal edge. In one example, a continuous or substantially continuous bead of adhesive of prescribed volume can be deployed into the sub-dermal cavity such that as the structural connecting element is inserted, so adhesive can be displaced and (e.g., fully) fill the cavities to provide a continuous or substantially continuous bond between them, with various examples including avoiding that there is an excess of adhesive that leaks out.

In one example, the structural joining element 712, 812 can have tapered edges that transfer load gradually into the adhesive in the cavity 710, 810 and then into the sub-dermal edge material 728, 828. This, too, in some examples, mitigates any load build-up as occurs with square-ended structural joining elements, which can lead to high load concentrations in the adhesive connection in various embodiments. This tapered edge can aid insertion of the structural connecting element into the adhesive in the cavity in some examples.

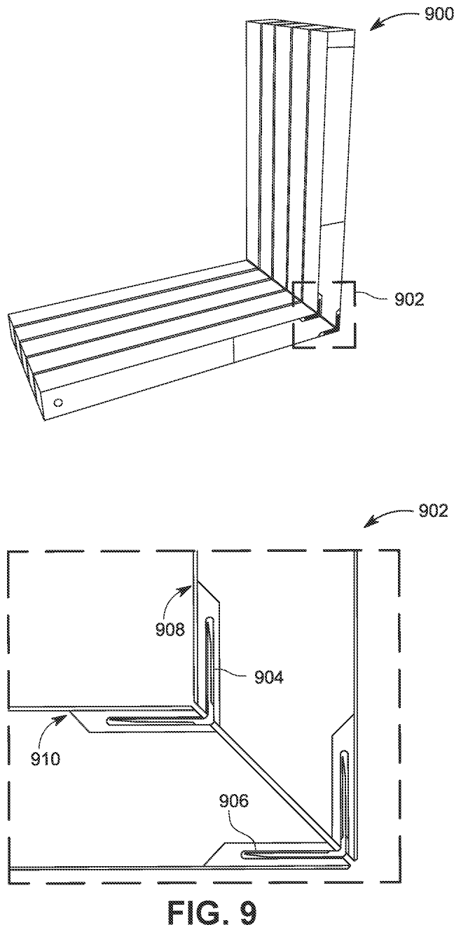

FIG. 9 illustrates an example diagram 900 of a 90-degree sub-dermal structural joint 902 that can follow the same or similar topology as the 180 degree joint (or any other angle), as described above in reference to FIGS. 5 and 6, and/or FIGS. 7 and 8. In this example, edges of panels 908, 910 may be cut an angle to accommodate the 90 degree join (e.g., 45 degrees), whereby the sub-dermal edge may also be cut or otherwise constructed to match the angle of edge of the panel 908, 910.

In various embodiments, structural joining elements 904, 906 can establish a double skeleton structure (inner and outer) that runs sub-dermally under the edge of every or one or more fiber-reinforced structural skin edges of two panels 908, 910 where it is joined to a neighboring skin. In some examples, such a double skeleton not only provides structural connection, but also waterproofing, air-tightness, acoustical separation, resistance to insects, and/or prevents fire penetrating into the core of the panel, and other benefits. Where panels have a free-standing end, in various embodiments, the structural jointing element may wrap or cover the exposed end, fully or substantially closing the core in a ubiquitous manner such that there are no or substantially no gaps in the totality of the building envelope. In one example, the topology of the joint is everywhere the same, with the depth below the fiber reinforced skin, and the distance from the centerline of the joint being standardized. In one example, the cavity in the sub-dermal edges can be topologically standard and continuous, with internal corners radiused to maintain the depth of cavity from the centerline of the joint between the panels.

Another way to think of various embodiments of the sub-dermal structural joining elements would be to imagine a continuous structural strip taped externally between adjacent panel fiber-reinforced skins (like a “Band Aid” that runs everywhere across all panel joints and around all edges), but where that strip has sunk into the edges by a standard depth everywhere, so forming a sub-dermal rather than supra-dermal continuity. Such “sinking” can descend the structural strips below the fiber-reinforced skins and into the sub-dermal edges, which might be imagined as liquid when the strip sinks, but which then solidify around the strips. The advantage of sub-dermal jointing in some embodiments can be to attain fire retardancy by encasing the structural joints in a fire-retardant solid edge. Some such embodiments can allow panels to be fully or partially finished off-building-site in the workshop, since the connection of the panels in various embodiments can be hidden below the surface, not affecting the surface finish of the composite structural panels. Some such embodiments can allow a robust panel edge where the sub-dermal edge provides solid support to the fiber-reinforced skin, and can allow it to be finished precisely, for example using diamond-encrusted routing bits or endmills to cleanly sever the glass-fiber skins.

The structural joining elements of various embodiments can be linear since the panels of various examples are planar, and in one example they are planar strips where the tapered edges are co-planar (180 degrees) (as described above in reference to FIGS. 5-8) or hinged at right-angles (90 degrees) (as described above in reference to FIG. 9), since most buildings and rooms have orthogonal, rectilinear walls/floors/ceilings. These typical-angle structural joining elements can in some examples be pultruded fiber-reinforced linear elements, fully consolidated fiber/matrix composite elements engineered to carry load across joints as needed or desired to attain code-compliant performance of the quasi-monocoque structure or for other suitable purpose.

In some examples, every or one or more panel edge can be comprised of a linear structural connection element that runs full length or substantially full length of the panel edge (e.g., without joints) to minimize any water, air or insect ingress. At the ends of the panel, where the edge turns, in various embodiments, there can be a corner element of the same topology relative to the joint centerline: for example, 90-degree corner elements or T-junctions or the like. In some examples, these can be mass-produced as standard corner pieces, which can allow for bonding a standard distance back from the corner so that it is a simple butt joint of two identical profiles set away from the complex and vulnerable-to-weather corner. The corner elements in various embodiments can be manufactured by any suitable method using materials that can be adhesively bonded to the linear edge strips, including in some examples the same fiber-reinforced composite material (pultruded, molded, thermally-formed, 3D printed, etc.). This can establish a continuous double skeleton of structural joining elements with occasional adhesively-bonded butt joints in various embodiments.

Where angles between adjacent panels are not orthogonal (not 90 degrees or 180 degrees), such as where there is need for a sloped roof or an angled wall, then in various embodiments, the linear structural joining elements can be formed to that angle, but in some embodiments, all other respects may maintain the same topology. Some such embodiments may be thought of as hinging the two tapered edges at the mid-point to the required angle. If the structural joining element is metal, in some examples this can be achieved by extrusion or by bending it on a brake press or similar device. If it is a fiber-reinforced strip, in some examples it can be pultruded or thermo-formed (e.g., if the matrix is thermoplastic) or formed in a mold by any suitable composite method such as wet lay-up, pre-preg, infusion, resin transfer molding, etc. The result in various embodiments can be to allow the tapered sides of the structural joining strip to remain parallel to the fiber-reinforced skins of the composite structural panels.

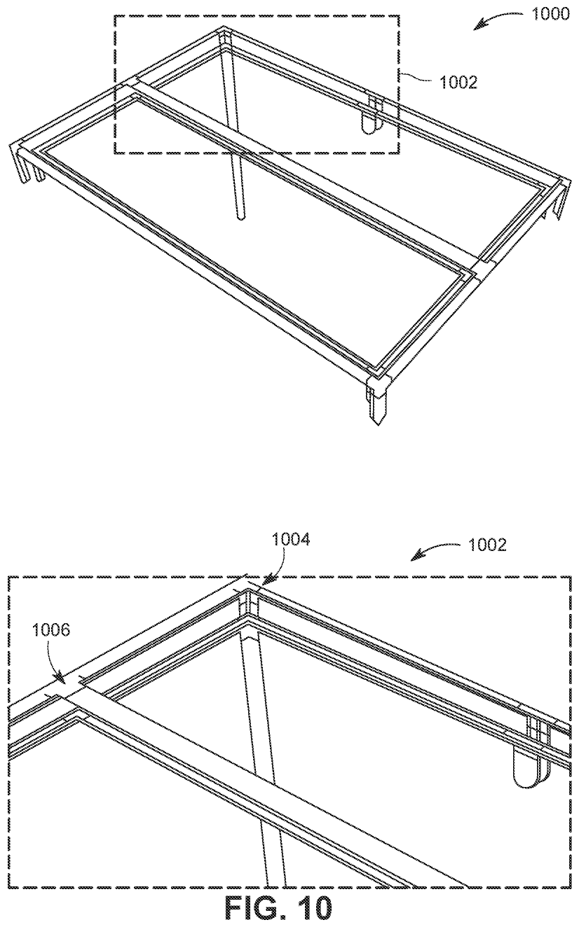

FIG. 10 illustrates a diagram 1000 showing one example of an orthogonal arrangement of sub-dermal structural joining elements showing 90-degree corners, such as corner 1004, and 90-degree T-junction (left center) 1006, detailed in expanded view or window 1002. In some cases, the join illustrated in FIG. 10 can be used in the close-out end condition at a window, where the joining element wraps to seal the panel joint (e.g., completely) against water, fire, insects, etc. At nodes where non-orthogonal panels meet, in various embodiments the sub-dermal structural joining elements can have the same topology as the orthogonal nodal joints, but where the tapered edges remain parallel to the fiber reinforced skin it is sub-dermal to.

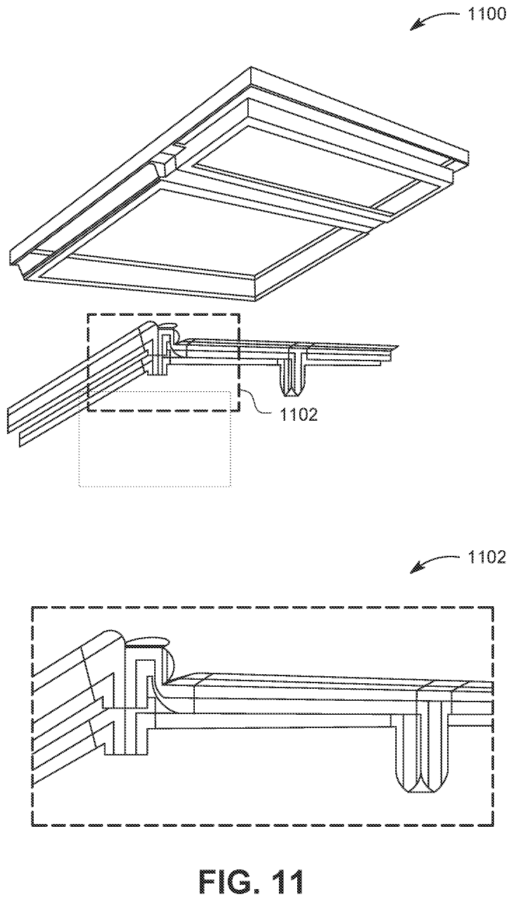

FIG. 11 illustrates a diagram 1100 of an example of sub-dermal edge material with cavity for sub-dermal joining element. The expanded view 1102 of diagram 1100 illustrates an example of a complex nodal joint at an angled roof/wall connection that is adhesively butt-jointed to the linear sub-dermal structural joining strips. Such a complex node, unique to this local condition in some examples, can be fabricated by 3D print methods in various examples, for example, using a compatible fiber-reinforced matrix resin to permit good adhesion and have similar thermal expansion as the rest of the assembly. However, this complex node can be fabricated by any suitable method in further embodiments.

Within a given building, the structural joining elements and the cavities in the sub-dermal edges can be consistent throughout in some examples, as will their sub-dermal depth below the fiber-reinforced skins. This can establish a ubiquitous geometry for the structural and waterproofing sub-dermal joining elements so that there are no gaps or misalignments anywhere (or substantially none) as may occur in some examples if any of the topological dimensions varied.

A building constructed suing the described panels and joining elements, in various embodiments, may be thought of as primarily comprised of a double skeleton of sub-dermal joining elements, angled as needed or desired. The double skeleton of sub-dermal joining elements can be subsumed by a sub-dermal edge mass that follows the fiber reinforced structural elements and can form a cavity around the tapered legs of the structural joining elements, with the gap between the cavity and the structural joining element filled with adhesive. The sub-dermal edge material can form a series of independent frames that describe or define the limit of the planar composite panels, with core materials filling inside the frames. A fiber-reinforced structural skin can be applied over the core and the edges, the composite panels then effectively bridging between joints, attaining weather-tightness and thermal insulation in the zones between the skeletal frame of the joining elements. Conceptually, in various embodiments, a building volume and arrangement can be described by multi-functional joints, with insulating, waterproofing, fire-retardant panels bridging between the voids left by the skeletal frame.

In some places in a building, there can be need for the sub-dermal structural joining element to end, but for the sub-dermal edge mass to continue. For example, this may occur where a structural connection between two adjacent panels ends at a window frame, or where one panel stops but the other continues. In some such cases, it can be desirable for the sub-dermal edge material to continue to provide continuous functionality to the panel edge (e.g., protecting the low-density core from weather, fire, water, insects, etc.). In some such cases, the sub-dermal structural connection can end in the sub-dermal edge mass, but so as to close off any potential gap in continuity of the joining element. These may be U-shaped elements, in some examples, which can be manufactured in various suitable ways such as molding, RTM, etc. In yet some examples, they can be atypical or even unique elements that can, in some embodiments, suit manufacturing via 3D print methods, such as using a fiber reinforcement and a matrix that are compatible with the linear joining elements so they can, in various examples, be effectively bonded and have similar low thermal expansion properties.

In some examples, the nodal joining elements may be formed to a standard dimension so that the “legs” butt the linear joining strips at a standard distance from the corner of a panel-panel connection. The strips in various embodiments can be cut to length to accurately fit from nodal element to nodal element, which in some examples can ensure that the skeletal frame is as tight-fitting as possible, as it can serve as a waterproofing barrier. This cutting can suit CNC fabrication methods in various embodiments but can be done by any suitable method as the cuts can be orthogonal no matter where they occur.

The joints between linear and nodal elements, in various embodiments, can be formed or milled such that they interlock to limit any tendency to split apart under thermal expansion and contraction. The joints can also be mechanically and/or adhesively joined to limit separation in some embodiments, although in some examples, if the joints are made of a fiber-reinforced composite material, adhesive bonding may be more suitable to limit stress fractures at high point load penetrations. In some cases, the linear and nodal sub-dermal joining elements can be milled to shape from larger strips or blocks using endmills or routers, whether in metal or composite. In yet some cases, the linear and nodal sub-dermal joining elements can be 3D printed, for example, where the strips and nodes are fiber-reinforced to allow them to carry load as needed in a given location. In some cases, the linear sub-dermal joining elements can be butt-jointed any number of times along an edge, but in some embodiments, there can be advantage to minimizing joints as they may be time-consuming and more vulnerable to water leakage than continuous joining elements.

The sub-dermal joining elements can be in any suitable structural material that has capacity to carry the load at a given location, but fiber-reinforced composite strips can offer advantages over metals in some embodiments. One such advantage can be low thermal expansion and contraction that can match more closely the fiber-reinforced composite structural skins to which the sub-dermal structural elements can be bonded. Another advantage in some embodiments can be that a fiber-reinforced joining element can have non-isotropic load-carrying capability by varying fiber type and direction. Varying and/or selecting fiber type and direction, in some examples, can allow a range of different structural properties to be attained in a given profile by different build-up of fibers, such that the vertical corners of a building carry load differently from a horizontal wall-floor joint.

In various embodiments, it can be desirable for linear joining elements to not touch the bottom of the cavity in the sub-dermal block at their outer edges as this can impose high stress concentrations in the sub-dermal edge material in some examples: the load may be best distributed into the adhesive in the cavity. In order to position the linear joining elements or nodal joining elements accurately in the cavity in the sub-dermal edge material so they do not get positioned too deeply or not deeply enough in the adhesive, or so that they do not wobble into an off-centered angle, in some embodiments, the ends of the linear strip can have small bumps that touch the bottom of the cavity (e.g., every foot or so). These can be small bumps to minimize any stress concentrations. An alternative or in addition to bumpy linear structural joining elements is to have bumps at the extremity of the cavity in the sub-dermal block such that a straight edge of the linear strip bottoms out on these occasional bumps that can have adhesive between them. Such bumps in the cavity can be produced in some examples by moving an excavating milling tool as it passes down the length of the block, or by other suitable method. In some cases, a shaped disc can mill a small cleft that traps the tapered edge of the linear joining strip in some examples, which may ensure it is parallel with the fiber-reinforced skins.

### Example Cavity In Sub-dermal Edge Material

The cavity in the sub-dermal mass that can serve as an element to transfer load from the structural joining element to the fiber-reinforced skins can, in one example, be formed by excavation using a disc or endmill or router, and in other examples can be cast or pultruded in the block (e.g., where it is pre-formed prior to assembly). By excavating the cavity once the panel is assembled, in various embodiments, the cavity can be precisely dimensioned relative to the panel edges, (that may be mechanically cut), such that the overall panel and the cavity-to-cavity dimensions are highly accurate, such as by using a CNC machine that typically operates to a 0.1 mm tolerance, or the like.

By solidifying the sub-dermal edge block as an oversized element, in various embodiments, there can be an allowance for tolerance in placing the uncut panel on a cutting machine table. Once secured, the edge and the cavities can be cut, milled, routed, etc. without moving the panel such that the dimensions over the full panel can be highly accurate. This can be desirable in some embodiments of a panelized system to avoid accumulating errors in the panel dimensions as the panels are assembled.

At inner corners of panel edges, in some embodiments, the cavity can maintain its depth around the corner, describing a circular form where the depth of the cavity can be consistent along the panel edges and from the corner that can create a radial point for the cavity to circle around. This circular cavity at internal corners may be milled by a disc shaped to the profile of the cavity, with the edge of the circular disc describing a circular cut prior to heading in a new direction. Such cavity can also be formed in some examples by an endmill inserted horizontally into the cavity and rotated. A disc tool can clear out the debris excavated from the cavity in a very efficient manner, so in various embodiments it can be a technically efficient solution to milling continuous cavities that describe circles at inner-corner cavities.

The cavities in the edges of the sub-dermal mass can be continuous along all panel edges that are joined to another panel, in some embodiments, and can turn across the ends of the panel edges where the wall ends in free space. Depending on the thickness of the wall, in various examples, this short cavity linking inner and outer edge cavities may be milled with a disc that suits that specific dimension, for instance 4″, 6″ diameter. In some examples it can be milled with an endmill of the same diameter as the width of the cavity.

### Example Fabrication Processes for Building Panel

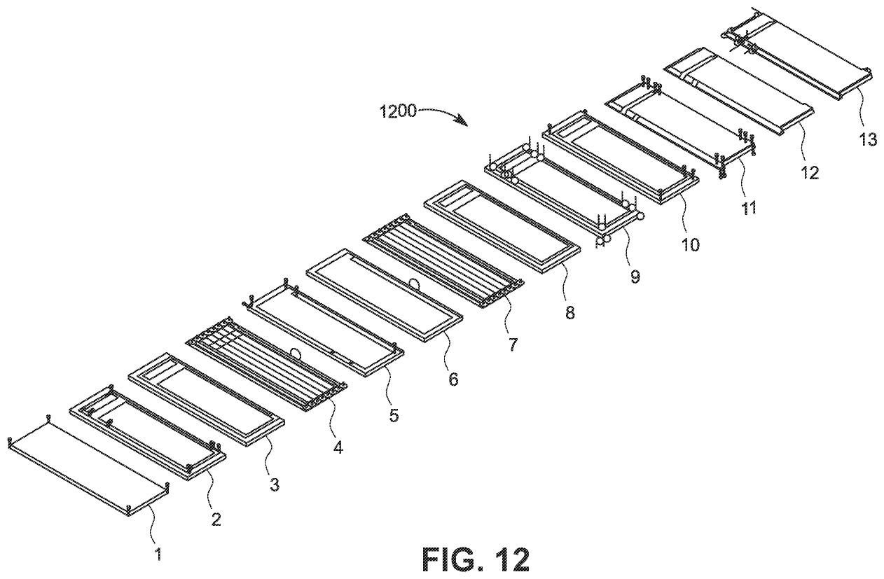

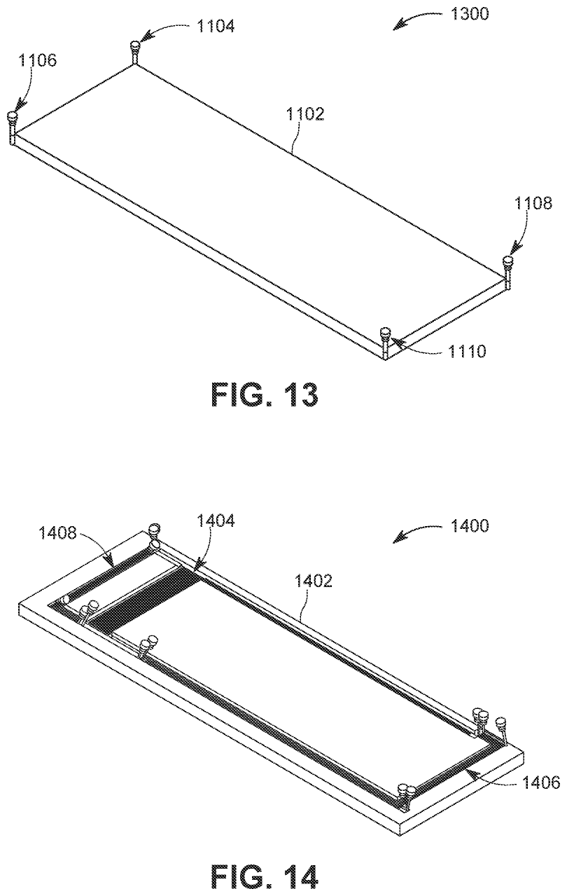

FIG. 12 illustrates a high level diagram 1200 including multiple stages 1-13 of a fabrication or manufacturing process to form a composite panel, according to the techniques described herein. FIGS. 13-25 illustrate each of the multiple stages of an example manufacturing process. The various embodiments of planar structural composite panels herein described can lend themselves in some examples to a prescribed sequence of manufacturing steps that can allow their production to be to a large degree automated or quasi-automated (or made by hand) using numeric command milling machines or similar mechanical equipment that can precisely cut, rout, trim large-format composite panels.

In the example diagram 1200 illustrated in FIG. 12, there can be anywhere from 10-20 discrete steps in the manufacture of a panel using these methods, although a higher or lower number of steps is possible. These steps can include additive and/or subtractive manufacture, either removing material or adding material according to need or as desired, building up specific property in a given location to suit the performance needed or desired at that area of the eventual building or for other suitable purposes.

FIG. 13 illustrates an example starting point or first step 1300. Diagram 1300 illustrates an example of an oversized motherboard 1302 of core material that is trimmed (e.g., to ensure it is perfectly square and to the required dimension to allow accurate placement on a machining table), as indicated by tools 1304-1310. In some cases, many panels could be nested on one motherboard to offer efficiency of manufacture.

FIG. 14 illustrates a next step 1400 in a process for manufacturing a composite panel. Diagram 1400 illustrates an example where recesses 1404, 1406, 1408 (indicated by shading) are excavated in the upper face of the core 1402 where other core materials or sub-dermal edge material can be located. In some cases, the recesses can be slightly oversized to allow tolerance when trimming later. The shading of recesses 1404, 1406, 1408 show toolpaths, which can vary depending on the tool used to excavate the core material.

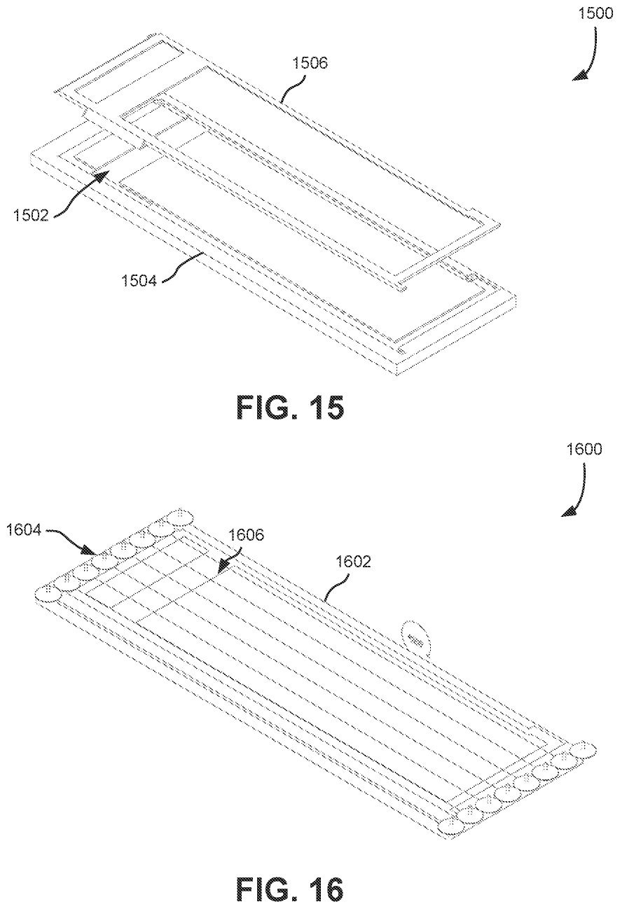

FIG. 15 illustrates a next step 1500 in a process for manufacturing a composite panel. Diagram 1500 illustrates an example where recesses 1502 excavated in the upper face of the core 1504 are filled with core materials and liquid, semi-liquid or solid materials 1506 that can form solid sub-dermal edges that can be continuous around all edges of the polygonal panels, taking on the shapes needed or desired in that particular location, for instance at 45 degrees slope where panels meet at 90 degrees. In some locations the sub-dermal material can be shallow in depth, but at edges where the panel end does not link to other panels it can extend in depth to encapsulate the core (e.g., fully).

FIG. 16 illustrates a next step 1600 in a process for manufacturing a composite panel. Diagram 1600 illustrates an example where the entire core 1602 with infilled sub-dermal material can be fly-milled or sanded (indicated by different locations of one or more tools 1604 that can pass over the surface of the sub-dermal material indicated by lines 1606) to be (e.g., perfectly) flat for application of a fiber-reinforced skin. In some cases, the core panel 1602 can then be flipped for sub-dermal infill on the other face. In the illustrated example, tool 1604 may be a diamond-encrusted disc performing the sanding, but other tools may be used.

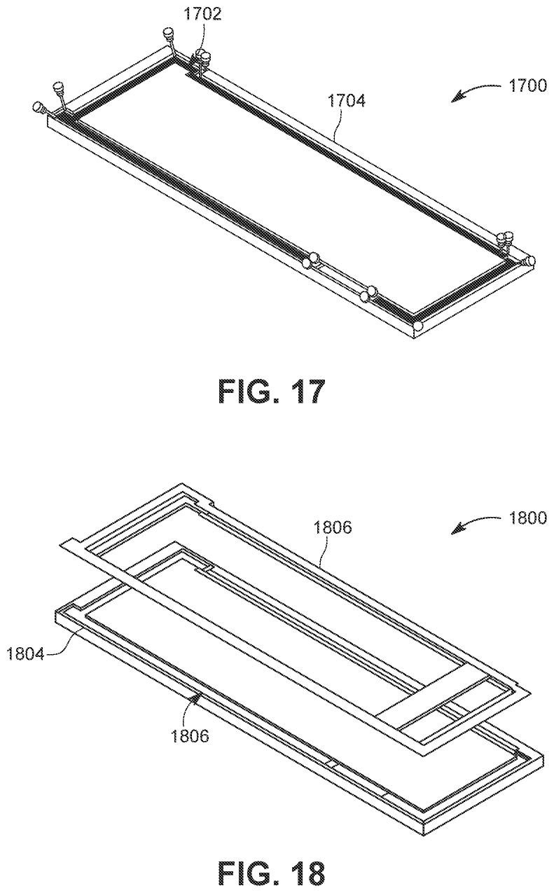

FIG. 17 illustrates a next step 1700 in a process for manufacturing a composite panel. Diagram 1700 illustrates an example where recesses 1702 are excavated in the lower face of the core 1704 where other core materials or sub-dermal edge material needs or is desired to be located. In some cases, recesses 1702 may be slightly oversized to allow tolerance when trimming. Lines show toolpath, which can vary depending on the tool used to excavate the core material.

FIG. 18 illustrates a next step 1800 in a process for manufacturing a composite panel. Diagram 1800 illustrates an example where recesses 1802 excavated in the lower face of the core 1804 are filled with core materials and liquid, semi-liquid or solid materials 1806 that form solid sub-dermal edges that can be continuous around all edges of the polygonal panels, taking on the shapes needed or desired in that location, such as for instance at 45 degrees slope where panels meet at 90 degrees. In some locations, the sub-dermal material can be shallow in depth, but at edges where the panel end does not link to other panels it can extend in depth to encapsulate the core (e.g., fully).

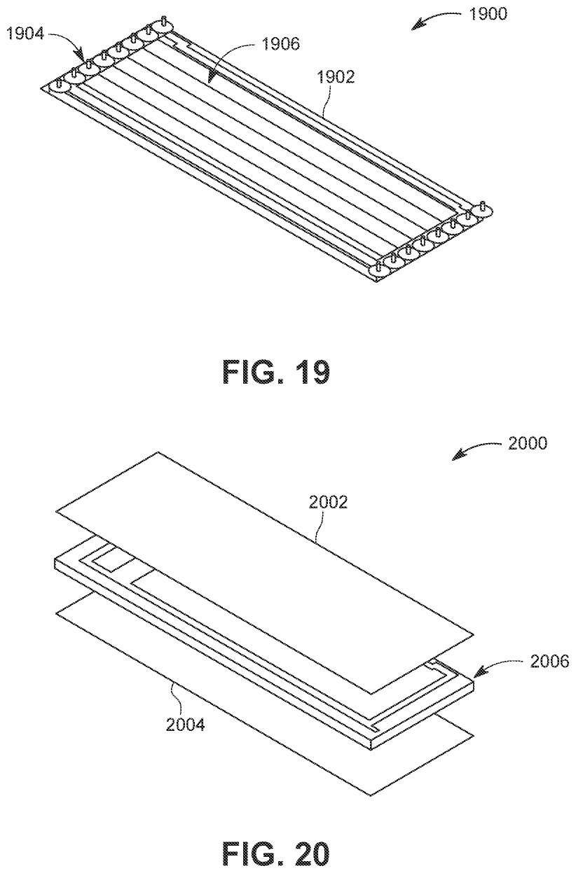

FIG. 19 illustrates a next step 1900 in a process for manufacturing a composite panel. Diagram 1900 illustrates an example where the entire core with infilled sub-dermal material 1902 can be fly-milled or sanded (indicated by different locations of one or more tools 1904 that can pass over the surface of the sub-dermal material indicated by lines 1906) to be (e.g., perfectly) flat for application of a fiber-reinforced skin. In the illustrated example, tool 1904 may be a diamond-encrusted disc performing the sanding, but other tools may be used.

FIG. 20 illustrates a next step 2000 in a process for manufacturing a composite panel. Diagram 2000 illustrates an example where fiber-reinforced skins 2002, 2004 are (e.g., fully) bonded over their (e.g., entire) area to the multi-material core 2006 such that the skins 2002, 2004 overlap the sub-dermal material inserts. The skins 2002, 2004 can be adhesively bonded or via the resin matrix if an infusion, hand lay-up, pre-impregnation or other process can be used.

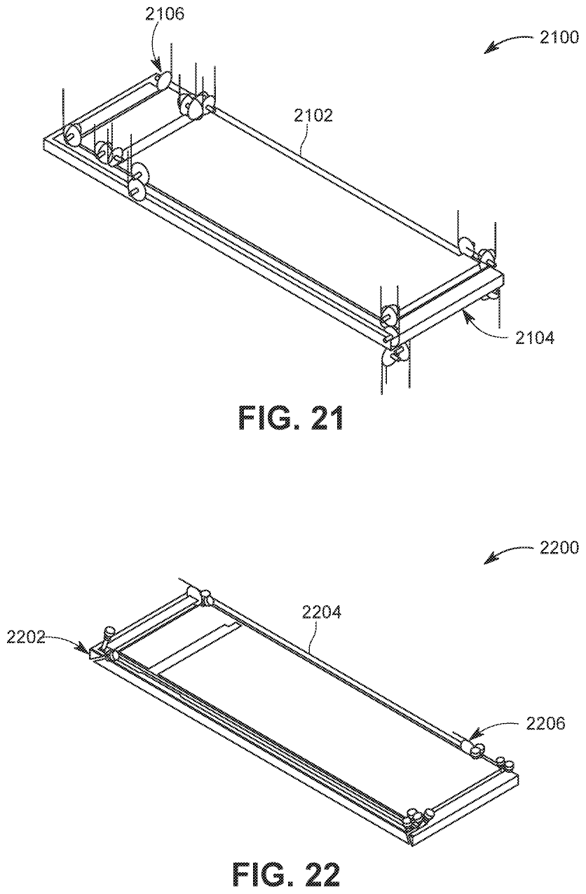

FIG. 21 illustrates a next step 2100 in a process for manufacturing a composite panel. Diagram 2100 illustrates an example where the fiber-reinforced skins 2102, 2104 are cleanly severed by a tool 2106 such as a diamond-encrusted router bit or disc or any other suitable tool, that cuts through the fibers and matrix into the supporting sub-dermal edge material, which can be below any edge.

FIG. 22 illustrates a next step 2200 in a process for manufacturing a composite panel. Diagram 2200 illustrates an example where the edges 2202 of the panel 2204 are severed using a saw, a disc or an endmill or any other tool 2206, cutting through almost to the lower fiber-reinforced skin or through the lower fiber-reinforced skin (e.g., if the tool is capable of cleanly severing the fibers and the sub-dermal edge material). These cuts, which may be at different angles according to the geometry needed at the particular location of the panel, can result in an accurate overall panel geometry where some or all fiber-reinforced skin edges are bonded (e.g., robustly) to a sub-dermal edge material strip. In some embodiments, care should be taken to apply downward or upward pressure to the upper and lower skins respectively to prevent de-bonding from the sub-dermal core during cutting, routing, etc.

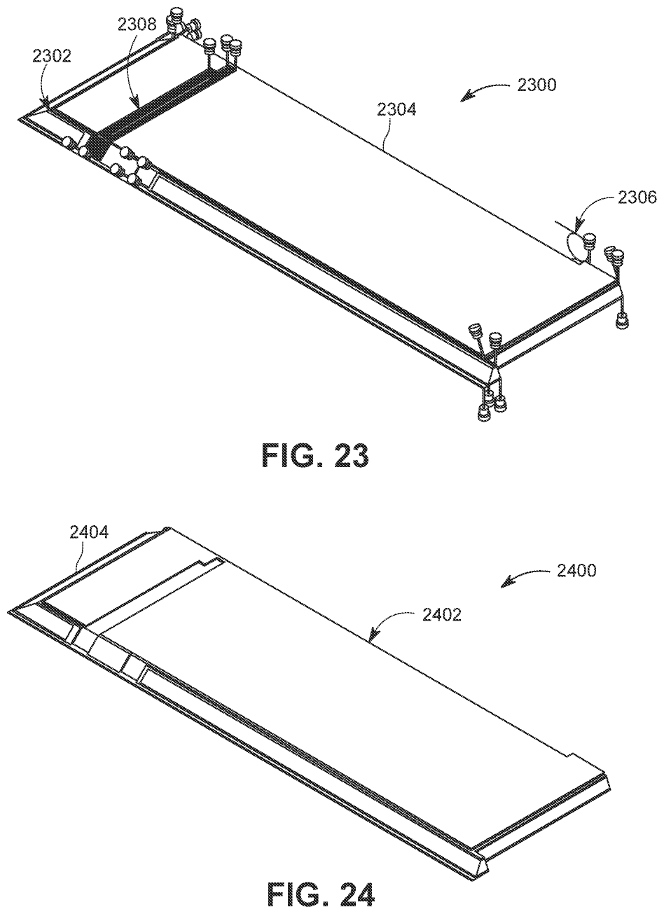

FIG. 23 illustrates a next step 2300 in a process for manufacturing a composite panel. Diagram 2300 illustrates an example where details 2302 can be excavated from the rough panel form 2304 using appropriate tools 2306 to attain finessed details as needed or desired in a given location. The toolpaths 2308 shown may vary according to different tools used to perform these detail operations.

FIG. 24 illustrates a next step 2400 in a process for manufacturing a composite panel. Diagram 2400 illustrates an example of one or more finishes 2402, such as wood or ceramic veneer, being applied to the panel 2404. In some cases, the one or more finishes 2402 may include intumescent or finish paint. In some cases, the finishing layer(s) 2402 can extend around the edges of the sub-dermal edge material to (e.g., fully) encapsulate the severed fiber-reinforced skin and sub-dermal edge, which in some examples can offer protection and aesthetic finesse.

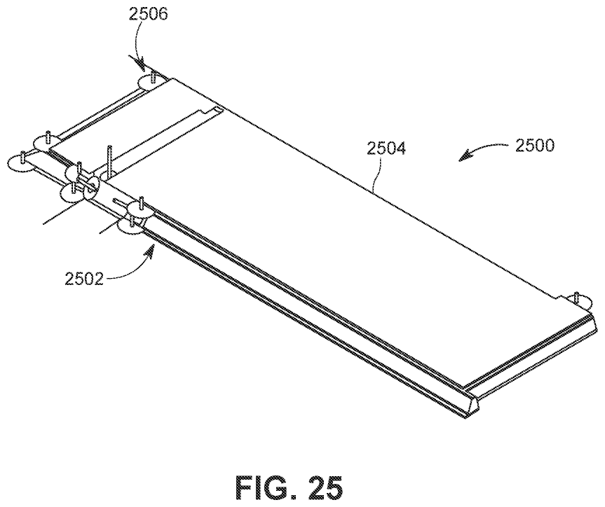

FIG. 25 illustrates a next step 2500 in a process for manufacturing a composite panel. Diagram 2500 illustrates an example where a continuous cavity 2502 can be excavated from the upper and lower sub-dermal mass 2504 to a standard depth and profile at a fixed dimension below the fiber-reinforced skins. In some examples, a diamond-encrusted disc 2506 may be an appropriate tool with a shaped profile that matches the internal shape of the cavity in some examples, but any suitable tool may be used. This can mill through any finishes that may cover the sub-dermal mass, which in some examples can ensure that those finishes extend to the edge of the structural jointing element when it is inserted into the cavity in the sub-dermal mass. At internal corners the cavity describes a circular sweep to maintain the depth consistent along the entire edge of the polygonal, multi-edge panel.

In various embodiments, a process for creating a building panel may include some or all of the above steps. In some cases, one or more of the above stages may be omitted to produce the panel. In some cases, there may be one or more additional steps, for example according to the complexity of a given panel, and the degree of supplemental finishing or detail that a given building might require or for other suitable purpose.

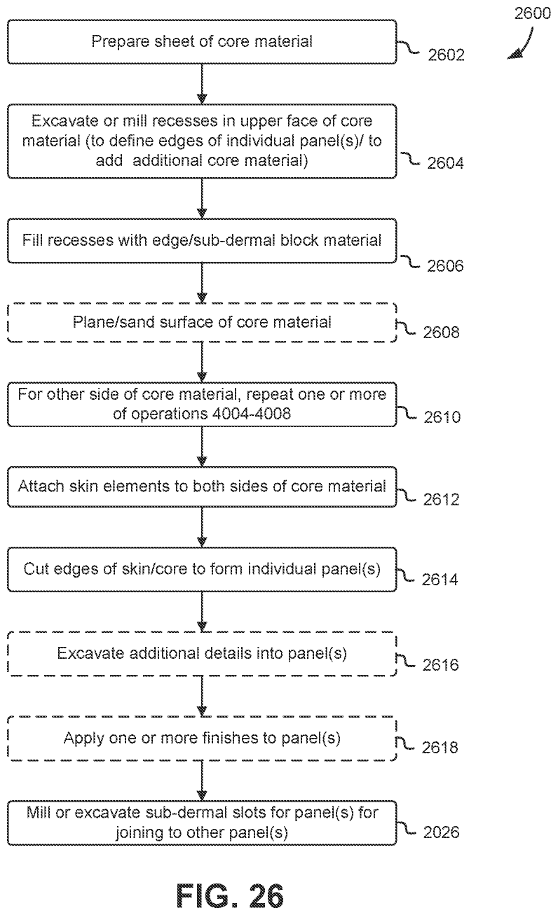

FIG. 26 illustrates an example process 2600 for constructing a building panel, such as may include none or more of stages 1300-2500 described above. As used herein, dashed lines indicating a certain operation may signify that that operation is optional, such that process 2600 may be performed with or without the so-indicated operation(s). Operations 2602-2620 may correspond to the operations and example stages 1300-2500 described above.

In some examples, process 2600 may begin at operation 2602, in which a sheet of core material may be prepared for fabrication of one or more building panels. Operation 2602 may include cutting the sheet to a size usable by a milling or other machinery. Next, at operation 2604, one or more areas or channels may be excavated from the upper face of the core material, where the excavated sections define boundaries of the one or more panels. In some cases, portions of the core material may be excavated for other purposes, such as to add one or more different materials to the core material, to provide different attributes (e.g., insulating properties, fire retardant properties, acoustical properties, and the like).

Next, at operation 2606, one or more of the recesses may be filled with a reinforced material, such as any of a variety of types of fiber reinforced material. In some cases, the material used to fill the recesses may be in liquid form; yet in other cases, the material used may take a semi-solid or solid form. As used herein, a semi-solid may refer to a paste, whereby the paste may be comprised of various materials, selected for specific performance attributes, including fire retardancy, water proofing, insulation properties, adhesion to different surfaces and different materials, and so on. As also described herein, any type of material, even those different than composites may be used to construct and form the various panelized building elements described herein, including various different aspects of panels, jointing elements, and so on, to a similar effect, including various metals, rubber, different type of plastic, organic material, and so on. The adhesives or gaskets used for these various materials may be selected to accommodate attributes of these materials.

Next, in some optional cases, the surface of the core may be sanded, milled, or otherwise processed to form a flat planar surface, for attachment of skin elements to the core material, at operation 2608. In various cases, one or more of operations 2604-2608 may be repeated for the other side of the core material, at operation 2610. In some cases, processes may only need to be performed on one side of the core material, such as where only one slot is formed in the sub-dermal edge of a given panel, for use with a single planar joining element. In cases where two planar joining elements are used for a given edge of at least one of the panels to be extracted from the sheet of core material, then at least operation 2604 and 2606 may be performed for the other side of the core material sheet.

The skin elements (e.g., sheets of some type of fiber reinforced material), may then be attached to both sides of the core material, at operation 2612. Edges may then be cut or milled (e.g., in one or multiple stages to cleanly cut skin and core materials, for example), to form one or more individual building panels from the larger sheet, at operation 2614. In some optional cases, other details may be excavated from one or both planar surfaces (or any of the edges) of the resulting one or more panels, at operation 2616. In some optional cases, one or more finishes, such as paint or coating material, thin veneer skin, such as wood or composite, may then be applied to one or both of the planar sides of the one or more panels (and/or edges) at operation 2618. Finally, one or more sub-dermal edges (e.g., slots or cavities as described above), may then be excavated, milled, or otherwise formed in one or more edges of the resulting panel(s).

### Example Manufacturing Facility

In various embodiments, step-by-step fabrication logic allows for automated or quasi-automated production (e.g., in some cases supplemented by-hand production) down an assembly line where dedicated equipment at each stage completes a set of given tasks that build towards a highly integrated planar composite panel. In some embodiments, such equipment is digitally controlled, and the panels can be entirely non-standard, allowing any suitable dimension, thickness and shape, and allowing any suitable joint typology. This in various embodiments can offer versatility of building form, with the specific geometries fed into the manufacturing protocol.

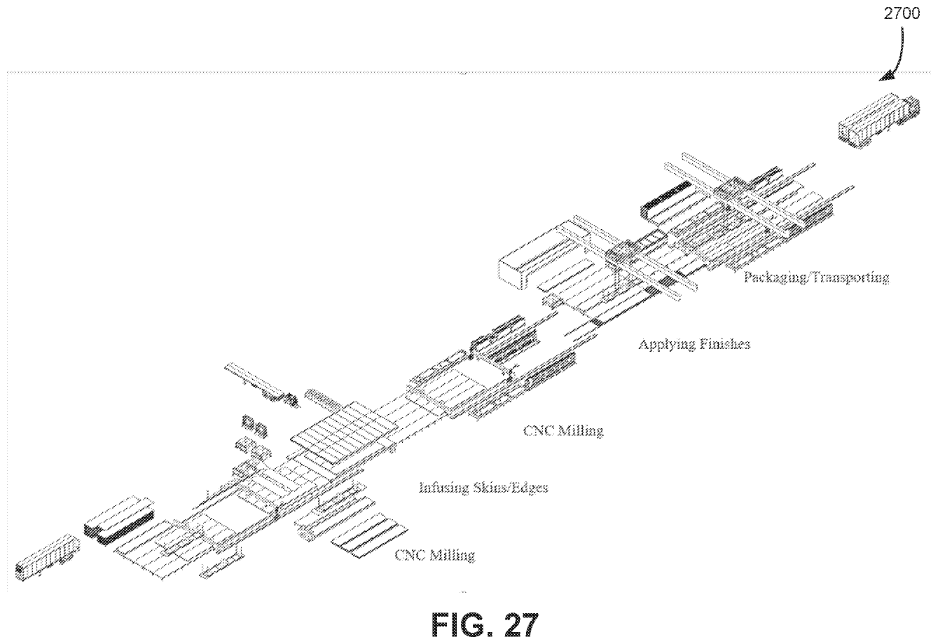

FIG. 27 illustrates an example diagram 2700 of a small automated production line for manufacturing the described building panels, such as using infusion methods. In some cases, the automated production line illustrated in FIG. 27 may include the following stages: core preparation, CNC or other milling, infusion of skins and/or edges, CNC or other milling, and applying one or more finishes.

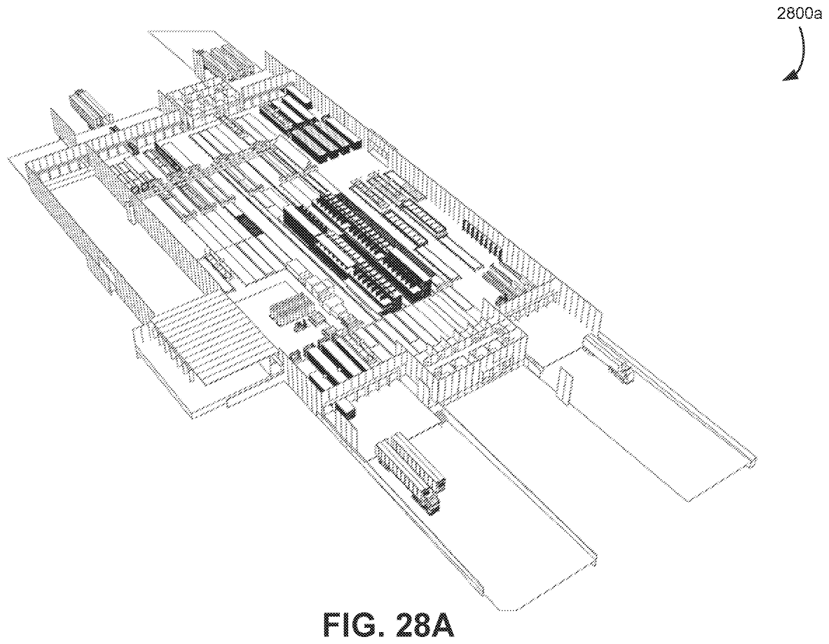

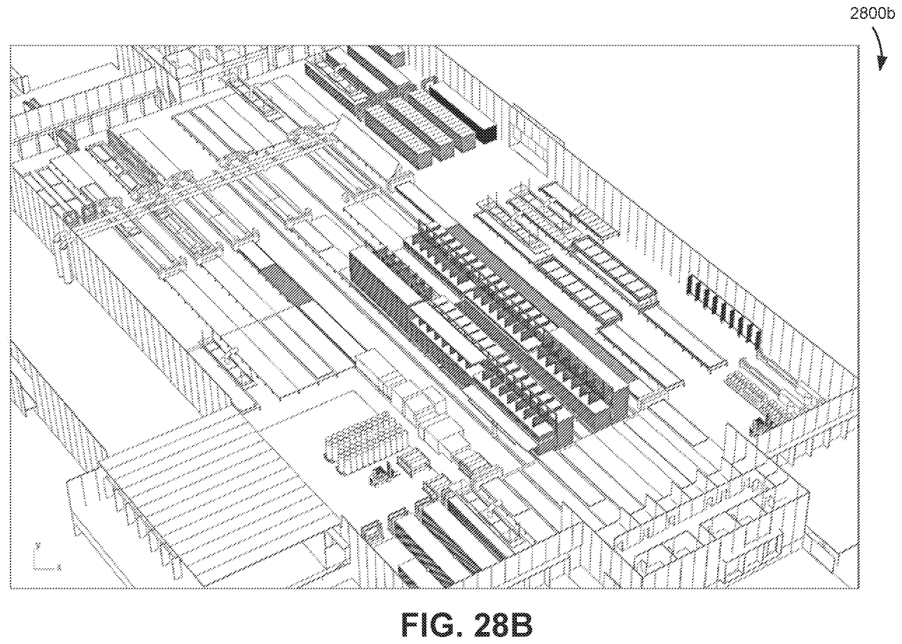

FIGS. 28A and 28B illustrates an example diagram 2800a and 2800b of a large automated multi-production line using lamination methods. In some cases, the system of diagram 2800a may be a multi-line production facility to manufacture integrated structural composite panels for building use by a step-by-step automated method, offering high production speed and high quality. In some cases, the system of diagram 2800b may be of a detailed view of the system of FIG. 28A.

### Example Houses and Buildings Showing Non-standard Versatility of Technology

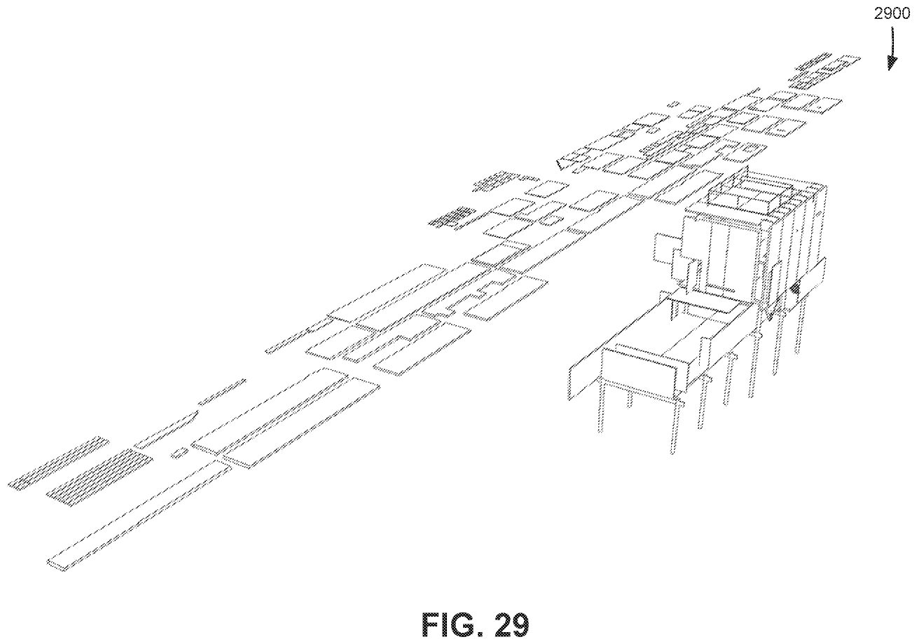

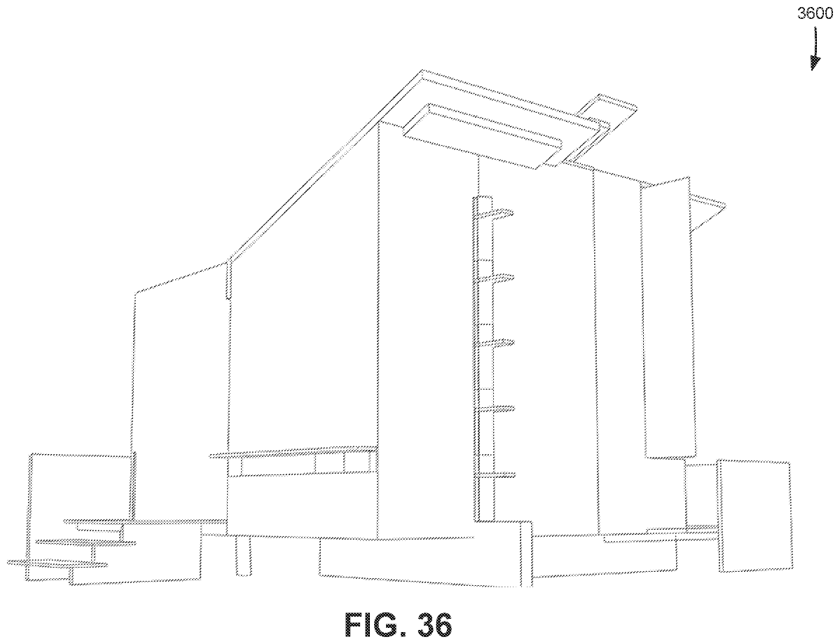

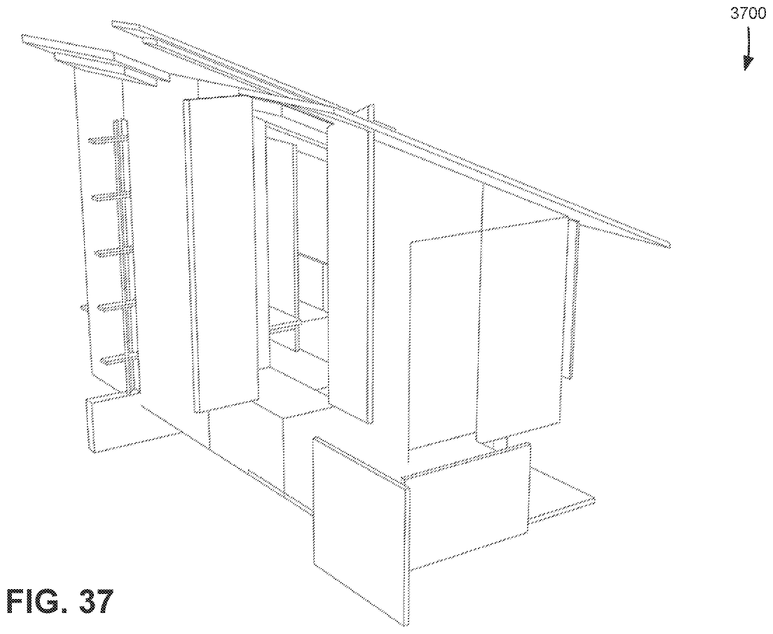

FIGS. 29-45 illustrate example buildings and structures that may be constructed using the described techniques.

FIG. 29 illustrates an example diagram 2900 of a composite structural panelized 3-storey 2400 square foot house. Diagram 2900 includes the structural composite panels that can be jointed to create floors, walls, roof, fixed furniture, doors, shutters, stair treads, etc. The panels are shown formatted to be manufactured via an automated production line as shown above.

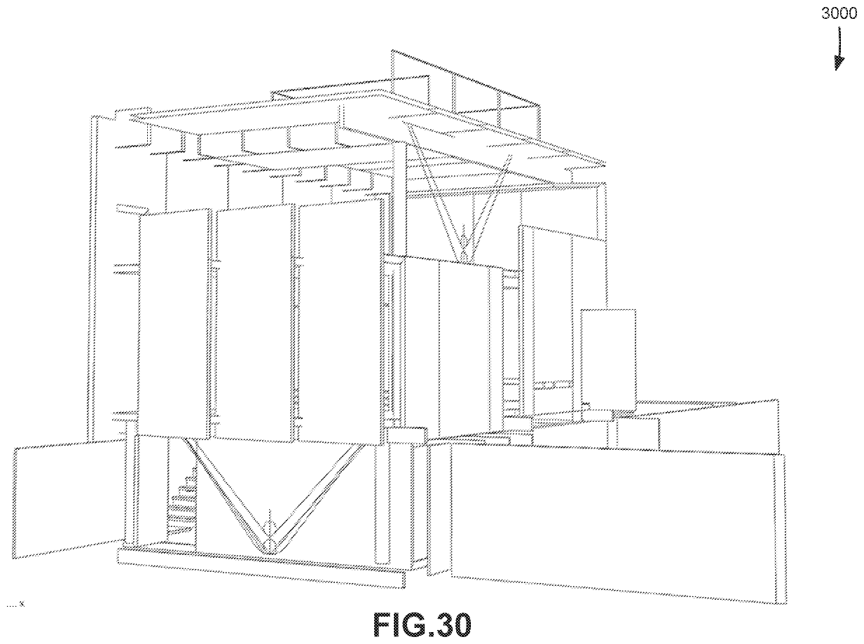

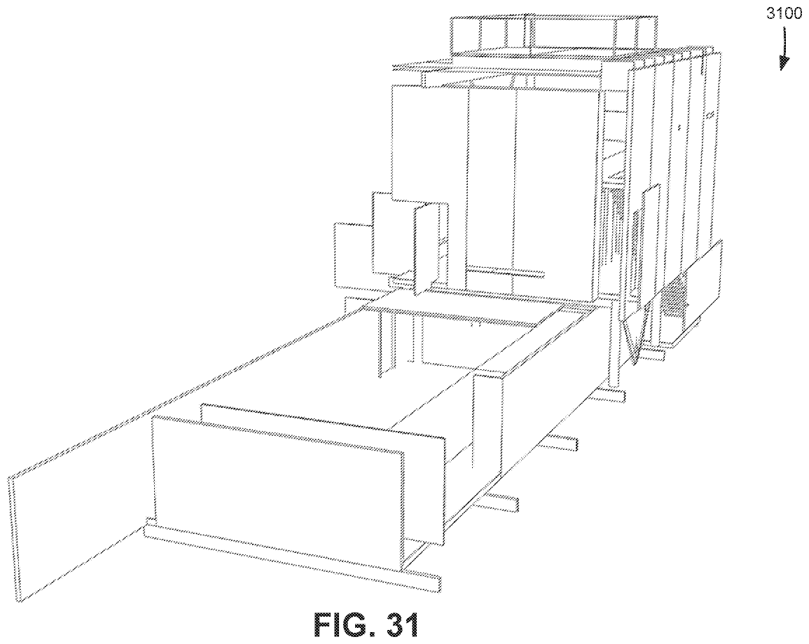

FIGS. 30-31 illustrates example diagrams 3000, 3100 of another composite structural panelized 3-storey 2400 square foot house. In this example, all (or substantially all) elements are planar composite structural panels that can be jointed to attain required building performance, joined to a fiberglass piled structure. Floors, walls, roof, doors, fixed furniture, stair treads, etc. can all be constructed from composite structural panels joined sub-dermally.

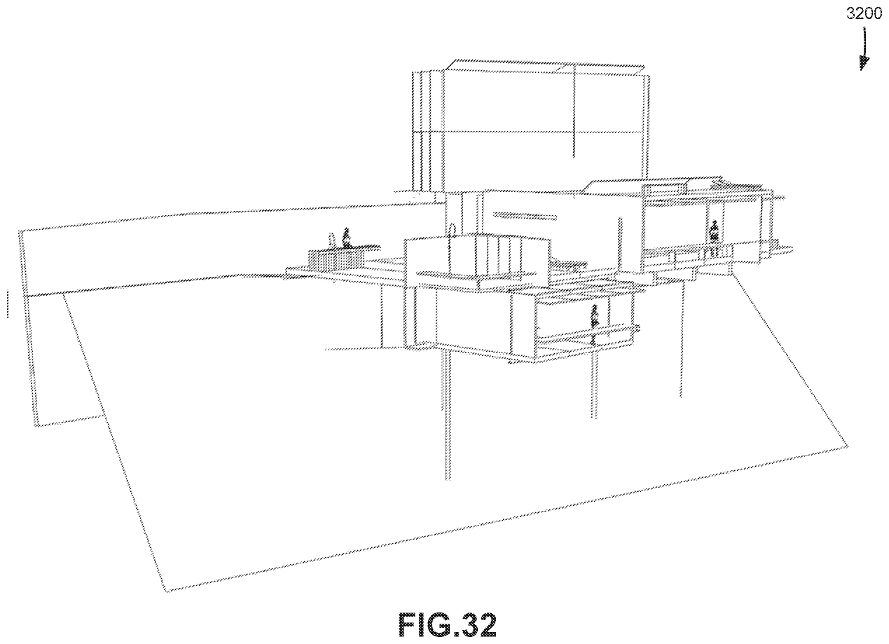

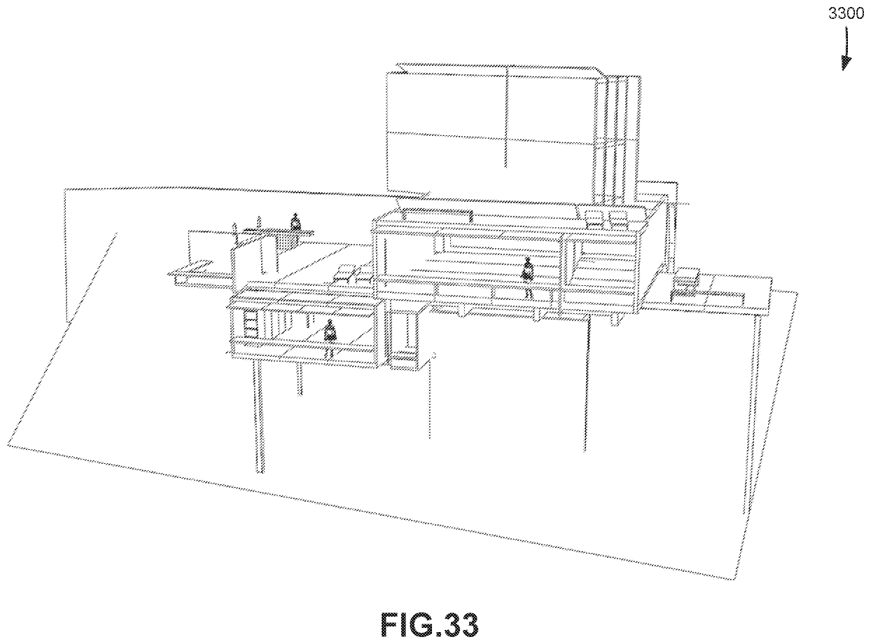

FIGS. 32-33 illustrates example diagrams 3200, 3300 of a cantilevered 3000 square foot composite panelized house on a hillside with bedroom element (upper box), living element (mid box) and guest element (lower box). Diagrams 3200 and 3300 illustrates views from side and front with composite panels showing their structural capacity in the cantilevered spaces and large spans.

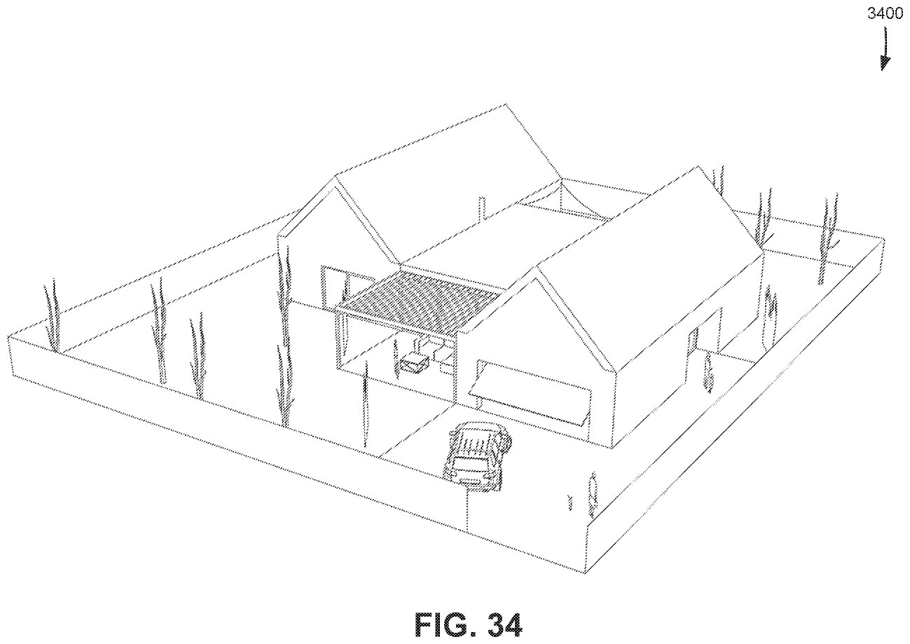

FIG. 34 illustrates an example diagram 3400 of a small single-family house consisting of two pavilions. Diagram 3400 includes flat roof mid-section (living), pitched roof far section (bedrooms), pitched roof near section (garage/kitchen/workroom), some or all of which may be constructed from composite structural panels.

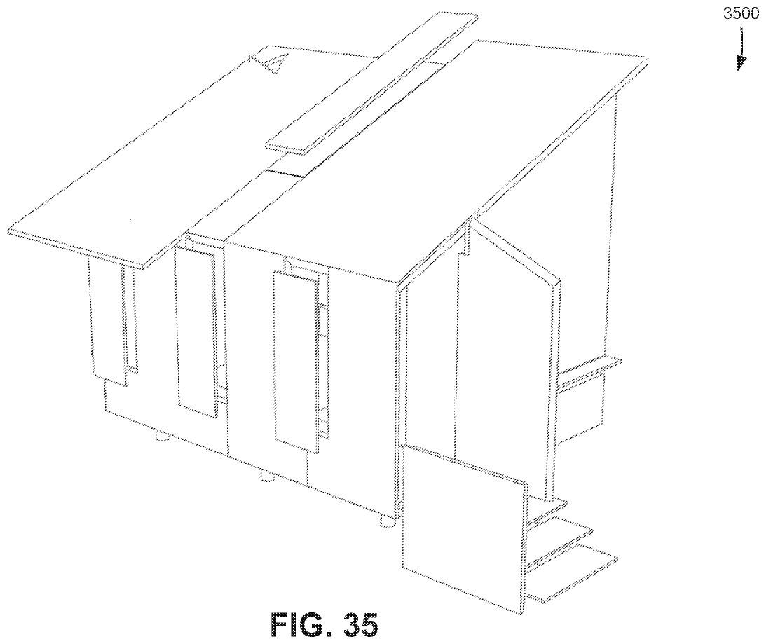

FIGS. 35-37 illustrates example diagrams and views 3500, 3600, 3700 of a micro house comprised of composite structural panels and fiberglass piling. In this example structure, the walls, roof, floor, stairs, balustrade, doors, shutters re all composite structural panels.

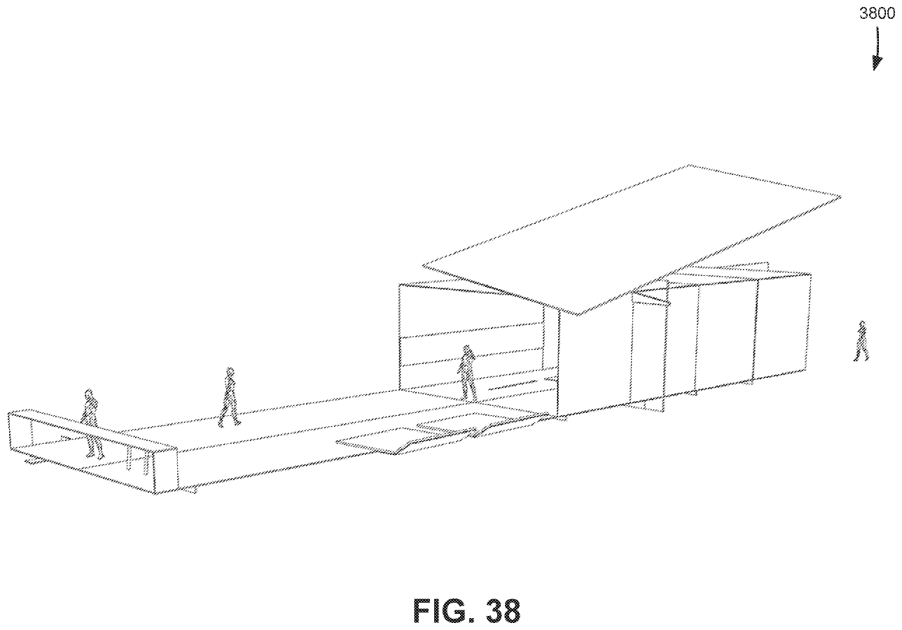

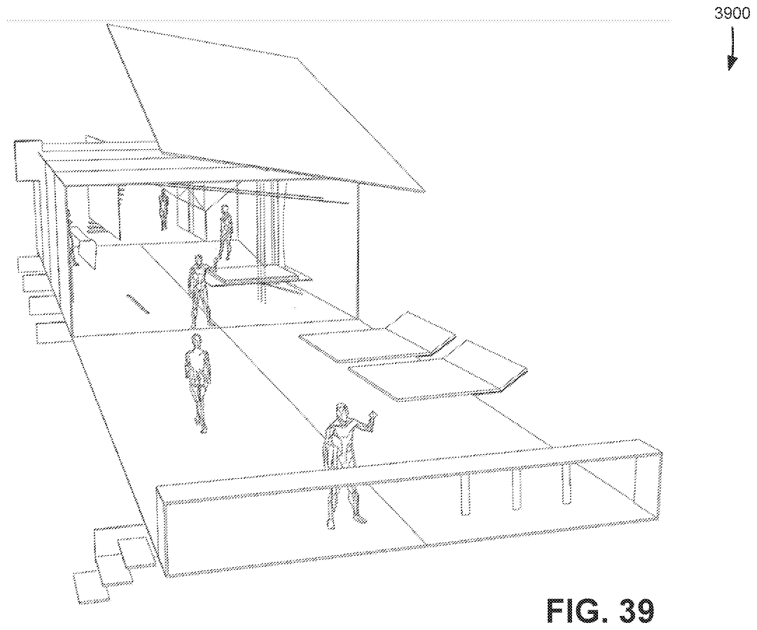

FIGS. 38-39 illustrates example diagrams and views 3800, 3900 of a small summer house with an external terrace and kitchen with large solar panel on the roof comprised of composite structural panels and fiberglass piling.

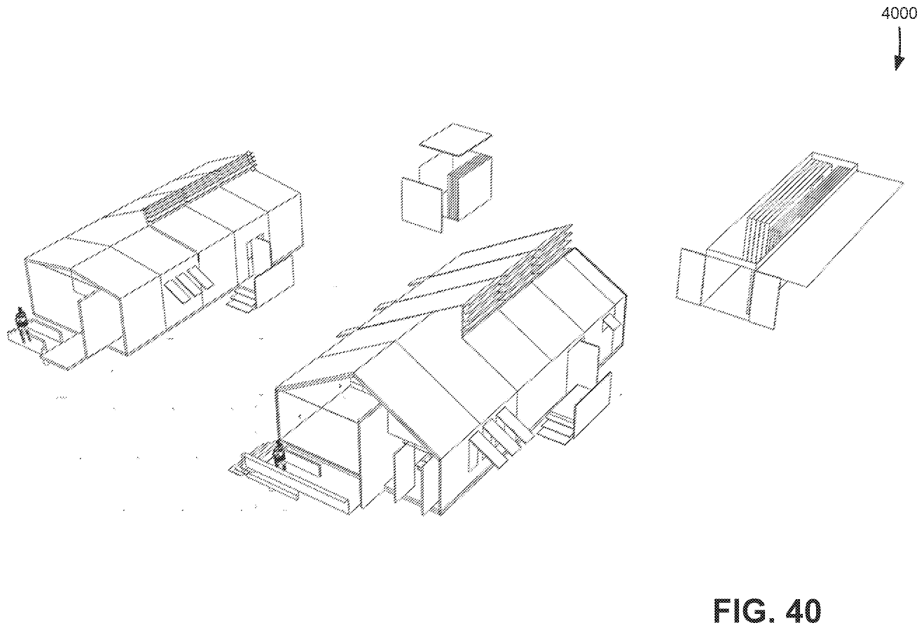

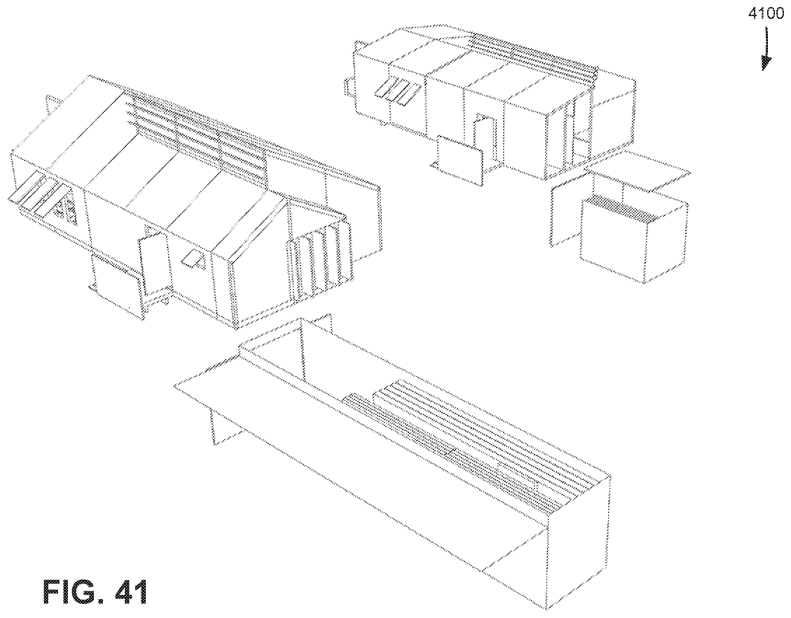

FIGS. 40-41 illustrates example diagrams and views 4000, 4100 of two iterations of a Flat Pack Containerized House that could be used for Post-Disaster Relief Housing

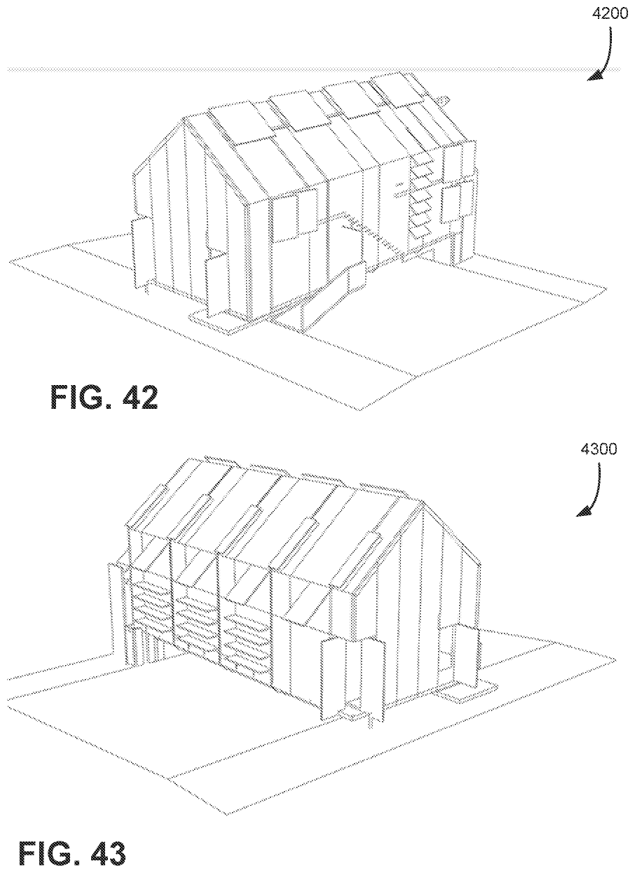

FIGS. 42-43 illustrates example diagrams and views 4200, 4300 of a 2-storey 4-bedroom house comprising of composite structural panels for walls, roof, floors, fixed furniture, and shutters. Views 4200, 4300 of a 2-storey, 4-bedroom house may exemplify composite structural panels joined to offer full functionality, including operable large-scale shutters.

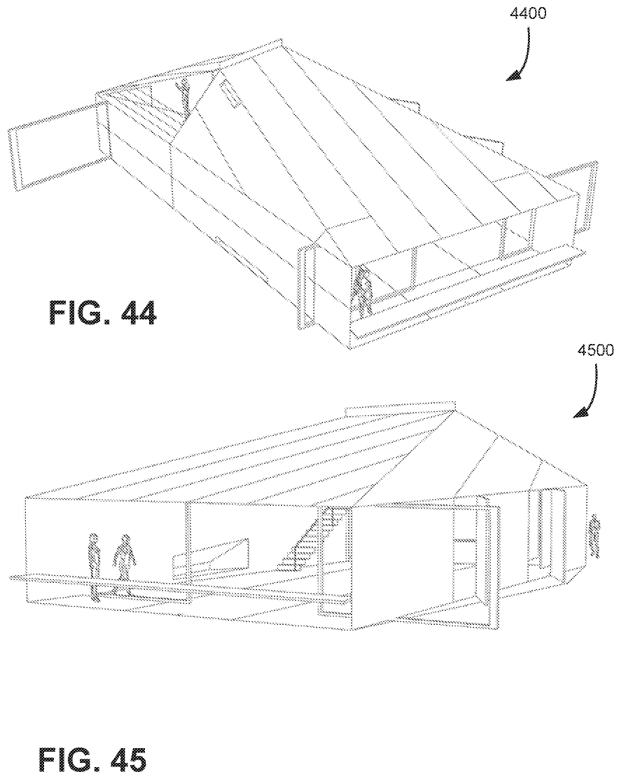

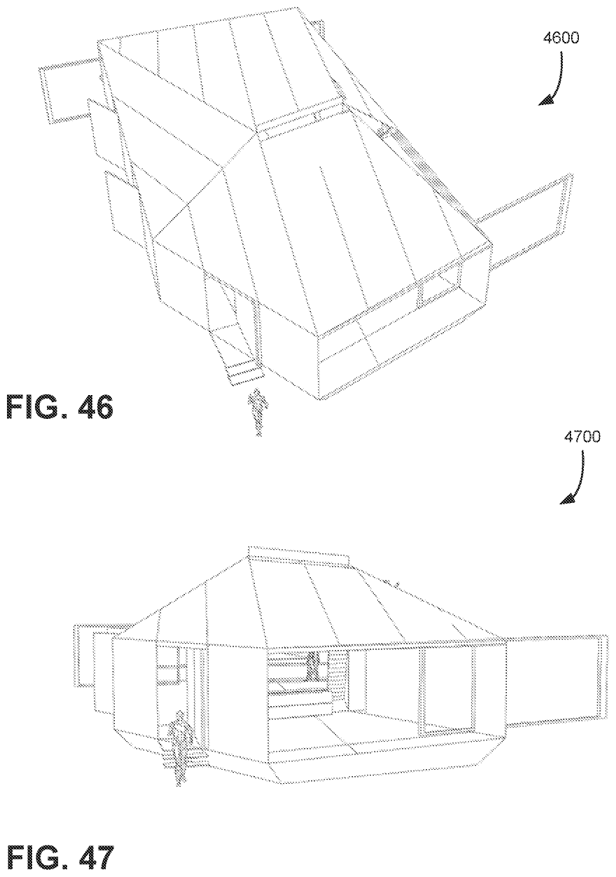

FIGS. 44-47 illustrates example diagrams and views 4400, 4500, 4600, 4700 of a small pitched-roof monocoque open-plan house. Views 4400, 4500 show a small pitched-roof monocoque open-plan house with solar skin on the roof comprised solely of jointed composite structural panels as primary structure. This structure has an internal sleeping mezzanine, with terraces front and back accessible via large sliding glass doors, and large full-height composite shutters that allow for cross-ventilation.

Embodiments of the present disclosure can be described in view of the following clauses:

1. A panelized building assembly, the assembly comprising:

a first composite planar panel comprising a core material sandwiched between two first skin elements and having a first edge at a first angle to the first composite planar panel, the first edge defining a first slot and a second slot within at least one first portion of reinforced material coupled to at least one of the first skin elements and between the first skin elements;

a second composite planar panel comprising a second core material sandwiched between two second skin elements and having a second edge at a second angle to the second composite planar panel, the second edge defining a third slot and a fourth slot within at least one second portion of reinforced material coupled to at least one of the second skin elements and between the second skin elements; and

a sub-dermal joining element comprising a first planar joining element and a second planar joining element oriented substantially in parallel forming a double skeleton structure for use in coupling the first composite planar panel to the second composite planar panel, wherein the first planar joining element, when placed within the first slot and the third slot, and the second planar joining element, when placed in the second and fourth slot, transfers a load between the first portion of reinforced material, at least one of the first skin elements, the second portion of reinforced material, and at least one of the second skin elements of the first composite planar panel and the second composite planar panel.

2. The panelized building assembly of clause 1, wherein upon the symmetric sub-dermal joining element being coupled to the first composite planar panel and the second composite planar panel, elastomeric adhesive between the first edge and the second edge transfers a sheer load between the first composite planar panel and the second composite planar panel.
3. The panelized building assembly of clause 1 or 2, wherein when the sub-dermal joining element further comprises a cross member joining the first planar joining element and the second first planar joining element, wherein upon the sub-dermal joining element being coupled to the first composite planar panel and the second composite planar panel, the cross member transfers a sheer load between the first composite planar panel and the second composite planar panel.
4. The panelized building assembly of any of clauses 1-3, wherein:

the first portion of reinforced material of the first composite planar panel comprises two distinct portions of reinforced material each bonded to one of the first skin elements, each defining one of the first slot and the second slot, and

the second portion of reinforced material of the second composite planar panel comprises two distinct portions of reinforced material each bonded to one of the second skin elements, each defining one of the third slot and the fourth slot.

5. The panelized building assembly of clause 4, wherein:

the first composite planar panel comprises a section of reinforced material connecting the two distinct portions of reinforced material, and

the second composite planar panel comprises a second section of reinforced material connecting the two distinct portions of reinforced material.

6. The panelized building assembly of any of clauses 1-5, wherein the first planar joining element and the second planar joining element each comprise at least one recess proximate to each end of the first planar joining element and the second planar joining element designed to receive an adhesive for joining the sub-dermal joining element to the first slot, the second slot, the third slot, and the fourth slot.
7. The panelized building assembly of any of clauses 1-6, wherein:

the first slot and the third slot each comprise at least one rounded corner opposite the first edge to reduce load placed on the core material of the first composite planar panel, and

the second slot and the third slot each comprise at least one rounded corner opposite the second edge to reduce load placed on the core material of the second composite planar panel.

8. The panelized building assembly of any of clauses 1-7, wherein the first planar joining element and the second planar joining element substantially span a width of the first composite planar panel and the second composite planar panel.
9. The panelized building assembly of any of clauses 1-8, wherein upon joining the first composite planar panel and the second composite planar panel using the sub-dermal joining element, the resulting interface forms a waterproof and fire-retardant joint.
10. The panelized building assembly of any of clauses 1-9, wherein

the first planar joining element decreases in a least one dimension along a length of the first planar joining element away from a center of the length of the first planar joining element, to accommodate adhesive placed in the first slot and the third slot, and

the second planar joining element decreases in a least one dimension along a length of the second planar joining element away from a center of the length of the second planar joining element, to accommodate adhesive placed in the second slot and the fourth slot.

11. The panelized building assembly of clause 10, wherein

the first planar joining element has a greatest value in the at least one dimension at a center of the first planar joining element along the length, and wherein the greatest value in the at least one dimension is approximately equal to a corresponding dimension of the first slot and the third slot, such that when adhesive is applied to interfaces between the first planar joining element and the first slot and the third slot, adhesive is urged into the first slot and the third slot, and

the second planar joining element has a greatest value in the at least one dimension at a center of the second planar joining element along the length, and wherein the greatest value in the at least one dimension is approximately equal to a corresponding dimension of the second slot and the fourth slot, such that when adhesive is applied to interfaces between the second planar joining element and the second slot and the fourth slot, adhesive is urged into the second slot and the fourth slot.

12. The panelized building assembly of any of clauses 1-11, wherein upon joining the first composite planar panel and the second composite planar panel using the sub-dermal joining element, the core material of the first composite planar panel is in communication with the core material of the second composite planar panel along at least a portion of the first edge and the second edge.
13. The panelized building assembly of any of clauses 1-12, wherein:

the first portion of reinforced material is bonded to the core material of the first composite planar panel, and

the second portion of fiber-reinforced material is bonded to the core material of the second composite planar panel.

14. The panelized building assembly of any of clauses 1-13, wherein:

the core material of the first composite planar panel comprises a first block made of at least one of foam, cork, balsa, or rubber proximate to the first portion of fiber-reinforced material, and

the core material of the second composite planar panel comprises a second block made of at least one of foam, cork, balsa, or rubber proximate to the second portion of fiber-reinforced material.

15. The panelized building assembly of any of clauses 1-14, wherein:

upon joining the first composite planar panel and the second composite planar panel, the sub-dermal joining element is mechanically fastened to the first composite planar panel and the second composite planar panel.

16. The panelized building assembly of any of clauses 1-15, further comprising:

a gasket, that when placed in between at least two of the first composite planar planal, the second composite planar planal, the first slot, the second slot, the third slot, the fourth slot, and the sub-dermal joining element, forms a sealed joint between the first composite planar planal, the second composite planar planal, and the sub-dermal joining element.

17. The panelized building assembly of any of clauses 1-16, wherein the core material has a high insulating value and has a first density that is less than a second density of the first and second skin elements.
18. The panelized building assembly of any of clauses 1-17, wherein the first composite planar panel comprises a third edge at a third angle to the first composite planar panel, the third edge defining a fifth slot and a sixth slot within at least one third portion of reinforced material coupled to at least one of the first skin elements and between the first skin elements, the panelized building assembly further comprising:

an edge finishing element, the edge finishing element spanning a height of the third edge and composed of the reinforced material, the edge finish element comprising two attachment elements that fit into and are aligned with the fifth slot and the sixth slot of the third edge of the first composite planar panel.

19. The panelized building assembly of any of clauses 1-18, wherein the first angle comprises one of 90 degrees or 180 degrees, and wherein the second angle comprises the same one of 90 degrees or 180 degrees.
20. A reinforced building panel, comprising:

a core, the core comprising a low density material;

a first reinforced skin element bonded to a first surface of the core and comprising a reinforced fibrous material; and

a second reinforced skin element bonded to second surface of the core opposite the first surface forming a layered structure, the layered structure comprising a first mating edge at an angle to the core and the first and the second reinforced skin elements;

a first reinforced block coupled to the first reinforced skin element and defining part of the first mating edge, the first reinforced block defining a first slot, spanning substantially a width of the reinforced building panel;

a second reinforced block coupled to the second reinforced skin element and defining a second part of the first mating edge, the second reinforced block defining a second slot, spanning substantially the width of the reinforced building panel, wherein the first slot and the second slot are dimensioned to receive a sub-dermal joining element for joining the reinforced building panel to another reinforced building panel, wherein upon receiving a load through at least one of first slot or the second slot via the sub-dermal the joining element, at least one of the first reinforced block or the second reinforced block distributes the load across the core and at least one of the first reinforced skin element or the first reinforced skin element.

21. The reinforced building panel of clause 20, wherein at least one of the first the reinforced block or the second the reinforced block comprises at least one rounded outside corner that is proximate to the core.
22. The reinforced building panel of clause 20 or 21, wherein at least one of the first slot or the second slot comprises at least one rounded internal corner.
23. The reinforced building panel of any of clauses 20-22, wherein at least one of the first reinforced skin element, the second reinforced skin element, the first reinforced block, or the second reinforced block comprises glass fiber and polymeric resin, or carbon fiber and polymeric resin.
24. The reinforced building panel of any of clauses 20-23, wherein at least part of the first mating edge is defined by the core.
25. The reinforced building panel of any of clauses 20-24, wherein at least one of the first slot or the second slot is tapered in at least one dimension extending away from the first mating edge.
26. A panelized building assembly, the assembly comprising:

a first composite planar panel comprising a core material sandwiched between two first reinforced skin elements and having a first mating edge, the first mating edge defining a first reinforced cavity within a first portion of reinforced material coupled to one of the first reinforced skin elements and a second reinforced cavity within a second portion of reinforced material coupled to the other of the first reinforced skin elements;

a second composite planar panel comprising the core material sandwiched between two second reinforced skin elements and having a second mating edge, the second mating edge defining a third reinforced cavity within a third portion of reinforced material coupled to one of the second reinforced skin elements and a fourth reinforced cavity within a fourth portion of reinforced material coupled to the other of the second reinforced skin elements; and

a biscuit comprising two planar joining elements for use in coupling the first composite planar panel to the second first composite planar panel, wherein the biscuit, upon engagement into the first cavity and the third cavity, and the second cavity and the fourth cavity, displaces force between at least one of:

the first portion of reinforced material, one of the first reinforced skin elements, the third portion of reinforced material, and one of the second reinforced skin elements, or

the second portion of reinforced material, the other of the first reinforced skin elements, the fourth portion of reinforced material, and the other of the second reinforced skin elements, and forms a substantially waterproof, and fire retardant joint between the first mating edge and the second mating edge of the first composite planar panel and the second composite planar panel.

27. The panelized building assembly of clause 26, wherein the first reinforced cavity and the second reinforced cavity are formed by milling the first portion of reinforced material and the second portion of reinforced material.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. A panelized building assembly, the assembly comprising:
a first composite planar panel comprising a core material sandwiched between two first skin elements and having a first edge at a first angle to the first composite planar panel, the first edge defining a first slot and a second slot within at least one first portion of reinforced material coupled to at least one of the first skin elements and between the first skin elements;
a second composite planar panel comprising a second core material sandwiched between two second skin elements and having a second edge at a second angle to the second composite planar panel, the second edge defining a third slot and a fourth slot within at least one second portion of reinforced material coupled to at least one of the second skin elements and between the second skin elements; and
a sub-dermal joining element comprising a first planar joining element and a second planar joining element oriented substantially in parallel forming a double skeleton structure for use in coupling the first composite planar panel to the second composite planar panel, wherein the first planar joining element, when placed within the first slot and the third slot, and the second planar joining element, when placed in the second and fourth slot, transfers a load between the first portion of reinforced material, at least one of the first skin elements, the second portion of reinforced material, and at least one of the second skin elements of the first composite planar panel and the second composite planar panel.

2. The panelized building assembly of claim 1, wherein upon the symmetric sub-dermal joining element being coupled to the first composite planar panel and the second composite planar panel, elastomeric adhesive between the first edge and the second edge transfers a sheer load between the first composite planar panel and the second composite planar panel.

3. The panelized building assembly of claim 1, wherein when the sub-dermal joining element further comprises a cross member joining the first planar joining element and the second first planar joining element, wherein upon the sub-dermal joining element being coupled to the first composite planar panel and the second composite planar panel, the cross member transfers a sheer load between the first composite planar panel and the second composite planar panel.

4. The panelized building assembly of claim 1, wherein:
the first portion of reinforced material of the first composite planar panel comprises two distinct portions of reinforced material each bonded to one of the first skin elements, each defining one of the first slot and the second slot, and
the second portion of reinforced material of the second composite planar panel comprises two distinct portions of reinforced material each bonded to one of the second skin elements, each defining one of the third slot and the fourth slot.

5. The panelized building assembly of claim 4, wherein:
the first composite planar panel comprises a section of reinforced material connecting the two distinct portions of reinforced material, and
the second composite planar panel comprises a second section of reinforced material connecting the two distinct portions of reinforced material.

6. The panelized building assembly of claim 1, wherein the first planar joining element and the second planar joining element each comprise at least one recess proximate to each end of the first planar joining element and the second planar joining element designed to receive an adhesive for joining the sub-dermal joining element to the first slot, the second slot, the third slot, and the fourth slot.

7. The panelized building assembly of claim 1, wherein:
the first slot and the third slot each comprise at least one rounded corner opposite the first edge to reduce load placed on the core material of the first composite planar panel, and
the second slot and the third slot each comprise at least one rounded corner opposite the second edge to reduce load placed on the core material of the second composite planar panel.

8. The panelized building assembly of claim 1, wherein the first planar joining element and the second planar joining element substantially span a width of the first composite planar panel and the second composite planar panel.

9. The panelized building assembly of claim 1, wherein upon joining the first composite planar panel and the second composite planar panel using the sub-dermal joining element, the resulting interface forms a waterproof and fire-retardant joint.

10. The panelized building assembly of claim 1, wherein
the first planar joining element decreases in a least one dimension along a length of the first planar joining element away from a center of the length of the first planar joining element, to accommodate adhesive placed in the first slot and the third slot, and
the second planar joining element decreases in a least one dimension along a length of the second planar joining element away from a center of the length of the second planar joining element, to accommodate adhesive placed in the second slot and the fourth slot.

11. The panelized building assembly of claim 10, wherein
the first planar joining element has a greatest value in the at least one dimension at a center of the first planar joining element along the length, and wherein the greatest value in the at least one dimension is approximately equal to a corresponding dimension of the first slot and the third slot, such that when adhesive is applied to interfaces between the first planar joining element and the first slot and the third slot, adhesive is urged into the first slot and the third slot, and
the second planar joining element has a greatest value in the at least one dimension at a center of the second planar joining element along the length, and wherein the greatest value in the at least one dimension is approximately equal to a corresponding dimension of the second slot and the fourth slot, such that when adhesive is applied to interfaces between the second planar joining element and the second slot and the fourth slot, adhesive is urged into the second slot and the fourth slot.

12. The panelized building assembly of claim 1, wherein upon joining the first composite planar panel and the second composite planar panel using the sub-dermal joining element, the core material of the first composite planar panel is in communication with the core material of the second composite planar panel along at least a portion of the first edge and the second edge.

13. The panelized building assembly of claim 1, wherein:
the first portion of reinforced material is bonded to the core material of the first composite planar panel, and
the second portion of fiber-reinforced material is bonded to the core material of the second composite planar panel.

14. The panelized building assembly of claim 1, wherein:
the core material of the first composite planar panel comprises a first block made of at least one of foam, cork, balsa, or rubber proximate to the first portion of fiber-reinforced material, and
the core material of the second composite planar panel comprises a second block made of at least one of foam, cork, balsa, or rubber proximate to the second portion of fiber-reinforced material.

15. The panelized building assembly of claim 1, wherein:
upon joining the first composite planar panel and the second composite planar panel, the sub-dermal joining element is mechanically fastened to the first composite planar panel and the second composite planar panel.

16. The panelized building assembly of claim 1, further comprising:
a gasket, that when placed in between at least two of the first composite planar planal, the second composite planar planal, the first slot, the second slot, the third slot, the fourth slot, and the sub-dermal joining element, forms a sealed joint between the first composite planar planal, the second composite planar planal, and the sub-dermal joining element.

17. The panelized building assembly of claim 1, wherein the core material has a high insulating value and has a first density that is less than a second density of the first and second skin elements.

18. The panelized building assembly of claim 1, wherein the first composite planar panel comprises a third edge at a third angle to the first composite planar panel, the third edge defining a fifth slot and a sixth slot within at least one third portion of reinforced material coupled to at least one of the first skin elements and between the first skin elements, the panelized building assembly further comprising:
an edge finishing element, the edge finishing element spanning a height of the third edge and composed of the reinforced material, the edge finish element comprising two attachment elements that fit into and are aligned with the fifth slot and the sixth slot of the third edge of the first composite planar panel.

19. The panelized building assembly of claim 1, wherein the first angle comprises one of 90 degrees or 180 degrees, and wherein the second angle comprises the same one of 90 degrees or 180 degrees.

20. A reinforced building panel, comprising:
a core, the core comprising a low density material;
a first reinforced skin element bonded to a first surface of the core and comprising a reinforced fibrous material; and
a second reinforced skin element bonded to second surface of the core opposite the first surface forming a layered structure, the layered structure comprising a first mating edge at an angle to the core and the first and the second reinforced skin elements;
a first reinforced block coupled to the first reinforced skin element and defining part of the first mating edge, the first reinforced block defining a first slot, spanning substantially a width of the reinforced building panel;
a second reinforced block coupled to the second reinforced skin element and defining a second part of the first mating edge, the second reinforced block defining a second slot, spanning substantially the width of the reinforced building panel, wherein the first slot and the second slot are dimensioned to receive a sub-dermal joining element for joining the reinforced building panel to another reinforced building panel, wherein upon receiving a load through at least one of first slot or the second slot via the sub-dermal the joining element, at least one of the first reinforced block or the second reinforced block distributes the load across the core and at least one of the first reinforced skin element or the first reinforced skin element.

21. The reinforced building panel of claim 20, wherein at least one of the first the reinforced block or the second the reinforced block comprises at least one rounded outside corner that is proximate to the core.

22. The reinforced building panel of claim 20, wherein at least one of the first slot or the second slot comprises at least one rounded internal corner.

23. The reinforced building panel of claim 20, wherein at least one of the first reinforced skin element, the second reinforced skin element, the first reinforced block, or the second reinforced block comprises glass fiber and polymeric resin, or carbon fiber and polymeric resin.

24. The reinforced building panel of claim 20, wherein at least part of the first mating edge is defined by the core.

25. The reinforced building panel of claim 20, wherein at least one of the first slot or the second slot is tapered in at least one dimension extending away from the first mating edge.

26. A panelized building assembly, the assembly comprising:
a first composite planar panel comprising a core material sandwiched between two first reinforced skin elements and having a first mating edge, the first mating edge defining a first reinforced cavity within a first portion of reinforced material coupled to one of the first reinforced skin elements and a second reinforced cavity within a second portion of reinforced material coupled to the other of the first reinforced skin elements;
a second composite planar panel comprising the core material sandwiched between two second reinforced skin elements and having a second mating edge, the second mating edge defining a third reinforced cavity within a third portion of reinforced material coupled to one of the second reinforced skin elements and a fourth reinforced cavity within a fourth portion of reinforced material coupled to the other of the second reinforced skin elements; and
a biscuit comprising two planar joining elements for use in coupling the first composite planar panel to the second first composite planar panel, wherein the biscuit, upon engagement into the first cavity and the third cavity, and the second cavity and the fourth cavity, displaces force between at least one of:
the first portion of reinforced material, one of the first reinforced skin elements, the third portion of reinforced material, and one of the second reinforced skin elements, or
the second portion of reinforced material, the other of the first reinforced skin elements, the fourth portion of reinforced material, and the other of the second reinforced skin elements, and forms a substantially waterproof, and fire retardant joint between the first mating edge and the second mating edge of the first composite planar panel and the second composite planar panel.

27. The panelized building assembly of claim 26, wherein the first reinforced cavity and the second reinforced cavity are formed by milling the first portion of reinforced material and the second portion of reinforced material.
